(19) United States
(12) Patent Application Publication
(10) Pub. No.: US 2012/0236115 A1
(43) Pub. Date: Sep. 20, 2012

(54) POST-FILTERING IN FULL RESOLUTION FRAME-COMPATIBLE STEREOSCOPIC VIDEO CODING

(75) Inventors: Rong Zhang, Columbus, OH (US); Ying Chen, San Diego, CA (US); Marta Karczewicz, San Diego, CA (US)

(73) Assignee: QUALCOMM INCORPORATED, San Diego, CA (US)

(21) Appl. No.: 13/252,081

(22) Filed: Oct. 3, 2011

Related U.S. Application Data
(60) Provisional application No. 61/452,590, filed on Mar. 14, 2011.

(51) Int. Cl. H04N 13/00

(52) U.S. Cl. 348/43; 348/E13.062

(57) ABSTRACT

Stereoscopic video data encoded according to a full resolution frame-compatible stereoscopic vide coding process. Such stereoscopic video data consists of a right view and a left that are encoded in half resolution versions in an interleaved base layer and an interleaved enhancement layer. When decoded, the right view and left view are filtered according to two sets of filter coefficients, one set for the left view and one set for the right view. The sets of filter coefficients are generated by an encoder by comparing the original left and right views to decoded versions of the left and right views.

This application claims the benefit of U.S. Provisional Application No. 61/452,590, filed Mar. 14, 2011, which is hereby incorporated by reference in its' entirety.

### TECHNICAL FIELD

This disclosure relates to techniques for video coding, and more specifically to techniques for stereo video coding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Extensions of some of the aforementioned standards, including H.264/AVC, provide techniques for stereo video coding in order to produce stereo or three-dimensional (“3D”) video. In particular, techniques for stereo coding have been used with the scalable video coding (SVC) standard (which is the scalable extension to H.264/AVC) and the multi-view video coding (MVC) standard (which has become the multiview extension to H.264/AVC).

Typically, stereo video is achieved using two views, e.g., a left view and a right view. A picture of the left view can be displayed substantially simultaneously with a picture of the right view to achieve a three-dimensional video effect. For example, a user may wear polarized, passive glasses that filter the left view from the right view. Alternatively, the pictures of the two views may be shown in rapid succession, and the user may wear active glasses that rapidly shutter the left and right eyes at the same frequency, but with a 90 degree shift in phase.

### SUMMARY

In general, this disclosure describes techniques for coding stereoscopic video data. Example techniques include post-filtering decoded stereoscopic video data according to left and right view filters. In one example, two sets of filter coefficients for each view (i.e., the left and right view) are used to filter decoded stereoscopic video data that was previously encoded according to a full resolution frame-compatible stereoscopic video coding process. Other examples of the disclosure describe techniques for generating the filter coefficients.

In one example of the disclosure, a method for processing decoded video data includes de-interleaving a decoded picture to form a decoded left view picture and a decoded right view picture. The decoded picture includes a first portion of a left view picture, a first portion of a right view picture, a second portion of a left view picture, and a second portion of a right view picture. The method further includes applying a first left-view specific filter to pixels of the decoded left view picture and applying a second left-view specific filter to pixels of the decoded left view picture to form a filtered left view picture, and applying a first right-view specific filter to pixels of the decoded right view picture and applying a second right-view specific filter to pixels of the decoded right view picture to form a filtered right view picture. The method may also include outputting the filtered left view picture and the filtered right view picture to cause a display device to display three-dimensional video comprising the filtered left view picture and the filtered right view picture.

In another example of the disclosure, an apparatus for processing decoded video data includes a video decoding unit. The video decoding unit is configured to de-interleave a decoded picture to form a decoded left view picture and a decoded right view picture. The decoded picture includes a first portion of a left view picture, a first portion of a right view picture, a second portion of a left view picture, and a second portion of a right view picture. The video decoding unit is further configured to apply a first left-view specific filter to pixels of the decoded left view picture and apply a second left-view specific filter to pixels of the decoded left view picture to form a filtered left view picture, and apply a first right-view specific filter to pixels of the decoded right view picture and apply a second right-view specific filter to pixels of the decoded right view picture to form a filtered right view picture. The video decoding unit may also be configured to output the filtered left view picture and the filtered right view picture to cause a display device to display three-dimensional video comprising the filtered left view picture and the filtered right view picture.

In another example of the disclosure, a method includes encoding a left view picture and a right view picture to form an encoded picture and decoding the encoded picture to form a decoded left view picture and a decoded right view picture. The method further includes generating left view filter coefficients based on a comparison of the left view picture and the decoded left view picture, and generating right view filter coefficients based on a comparison of the right view picture and the decoded right view picture.

In another example of the disclosure, an apparatus for encoding video data includes a video encoding unit. The video encoding unit is configured to encode a left view picture and a right view picture to form an encoded picture and decode the encoded picture to form a decoded left view picture and a decoded right view picture. The video encoding unit is further configured to generate left view filter coefficients based on a comparison of the left view picture and the decoded left view picture and generate right view filter coefficients based on a comparison of the right view picture and the decoded right view picture.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating one example of frame-compatible stereoscopic video coding.

FIG. 2 is a conceptual diagram illustrating one example of an encoding process in full resolution frame-compatible stereoscopic video coding.

FIG. 3 is a conceptual diagram illustrating one example of a decoding process in full resolution frame-compatible stereoscopic video coding.

FIG. 4 is a block diagram illustrating an example video coding system.

FIG. 5 is a block diagram illustrating an example video encoder.

FIG. 6 is a block diagram illustrating an example video decoder.

FIG. 7 is a block diagram illustrating an example post-filtering system.

FIG. 8 is a conceptual diagram illustrating an example filter mask for a left view picture.

FIG. 9 is a conceptual diagram illustrating an example filter mask for a right view picture.

FIG. 10 is a flowchart illustrating an example method of decoding and filtering stereoscopic video.

FIG. 11 is a flowchart illustrating an example method of encoding stereoscopic video and generating filter coefficients.

### DETAILED DESCRIPTION

In general, this disclosure describes techniques for coding and processing stereoscopic video data, e.g., video data used to produce a three-dimensional (3D) effect. To produce a three-dimensional effect in video, two views of a scene, e.g., a left eye view and a right eye view, may be shown simultaneously or nearly simultaneously. Two pictures of the same scene, corresponding to the left eye view and the right eye view of the scene, may be captured from slightly different horizontal positions, representing the horizontal disparity between a viewer's left and right eyes. By displaying these two pictures simultaneously or nearly simultaneously, such that the left eye view picture is perceived by the viewer's left eye and the right eye view picture is perceived by the viewer's right eye, the viewer may experience a three-dimensional video effect.

In a full resolution frame-compatible stereoscopic video coding process, de-interleaving the reconstructed frame-compatible left and right views from the base layer and enhancement layer may cause video quality issues. Undesirable video artifacts, such as spatial quality inconsistency across rows or columns, may be present. Such spatial inequality may exist because the decoded base view and decoded enhancement view may have different types and levels of coding distortions because the encoding process used for the base and enhancement layer may utilize different prediction modes, quantization parameters, partition sizes, or may be sent at different bit rates.

In view of these drawbacks, the present disclosure proposes techniques for post-filtering decoded stereoscopic video data according to left view and right view filters. In one example, two sets of filter coefficients for each view (i.e., the left and right view) are used to filter decoded stereoscopic video data that was previously encoded according to a full resolution frame-compatible stereoscopic video coding process. Other examples of the disclosure describe techniques for generating the filter coefficients for the left view and right view filters.

According to one example of the disclosure, the two sets of filter coefficients for the left view are based on a half-resolution portion of the left view encoded in a base layer and a half-resolution portion of the left view encoded in an enhancement layer. Similarly, the two sets of filter coefficients for the right view are based on a half-resolution portion of the right view encoded in a base layer and a half-resolution portion of the right view encoded in an enhancement layer.

Other examples of the disclosure describe techniques for generating the filter coefficients. Filter coefficients are generated by a video encoder by first encoding left view and right pictures and then decoding the left view and right view pictures. The decoded left view and right view pictures are then compared to the original left view and right view pictures to determine the filter coefficients. In one example, left view filter coefficients are generated by minimizing the mean-squared error between a filtered version of the decoded left view picture and the left view picture, and right view filter coefficients are generated by minimizing a mean-squared error of a between a filtered version of the decoded right view picture and the right view picture. This disclosure generally refers to a “picture” as a frame of a view.

In addition, this disclosure generally refers to a “layer” that may include a series of frames having similar characteristics. According to aspects of the disclosure, a “base layer” may include a series of packed frames (e.g., a frame that includes data for two views at a single temporal instance), and each picture of each view included in the packed frame may be encoded at a reduced resolution (e.g., a half resolution). According to other aspects of the disclosure, an “enhancement layer” may include data that can be used to reproduce a full resolution picture when combined with the half resolution data of the base layer. Alternatively, if the data of the enhancement layer is not received, the data of the base layer may be upsampled to produce the full resolution picture, e.g., by interpolating missing data of the base layer that would otherwise be provided by the enhancement layer.

The techniques of this disclosure are applicable for use in stereoscopic video coding processes. The techniques of this disclosure will be described with reference to the multi-view video coding (MVC) extension of the H.264/AVC (advanced video coding) standard. According to some examples, the techniques of this disclosure may also be used with the scalable video coding (SVC) extension of H.264/AVC. While the following description will be in terms of H.264/AVC, it should be understood that the techniques of this disclosure may be applicable for use with other multi-view or stereoscopic video coding processes, or with future multi-view or stereoscopic extensions to currently proposed video coding standards, such as the high efficiency video coding (HEVC) standard and extensions thereof.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. Video encoder and decoders typically operate on video blocks within individual video frames in order to encode and/or decode the video data. A video block may correspond to a macroblock or a partition of a macroblock. The video blocks may have fixed or varying sizes, and may differ in size according to a specified coding standard. Each video frame may include a plurality of slices. Each slice may include a plurality of macroblocks, which may be arranged into partitions, also referred to as sub-blocks.

As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16×16, 16×8, 8×16, 8×8, 8×4, 4×8 and 4×4 for luma components and corresponding scaled sizes for chroma components. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Block sizes that are less than 16 by 16 may be referred to as partitions of a 16 by 16 macroblock. Video blocks may comprise blocks of pixel data in the pixel domain, or blocks of transform coefficients in the transform domain, e.g., following application of a transform such as a discrete cosine transform (DCT), an integer transform, a wavelet transform, or a conceptually similar transform to residual video block data representing pixel differences between coded video blocks and predictive video blocks. In some cases, a video block may comprise blocks of quantized transform coefficients in the transform domain.

Smaller video blocks can provide better resolution, and may be used for locations of a video frame that include high levels of detail. In general, macroblocks and the various partitions, sometimes referred to as sub-blocks, may be considered video blocks. In addition, a slice may be considered to be a plurality of video blocks, such as macroblocks and/or sub-blocks. Each slice may be an independently decodable unit of a video frame. Alternatively, frames themselves may be decodable units, or other portions of a frame may be defined as decodable units. The term “coded unit” may refer to any independently decodable unit of a video frame such as an entire frame, a slice of a frame, a group of pictures (GOP) also referred to as a sequence, or another independently decodable unit defined according to applicable coding techniques.

Following intra-predictive or inter-predictive coding to produce predictive data and residual data, and following any transforms (such as the 4×4 or 8×8 integer transform used in H.264/AVC or a discrete cosine transform DCT) applied to residual data to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than m.

Following quantization, entropy coding of the quantized data may be performed, e.g., according to content adaptive variable length coding (CAVLC), context adaptive binary arithmetic coding (CABAC), or another entropy coding methodology. A processing unit configured for entropy coding, or another processing unit, may perform other processing functions, such as zero run length coding of quantized coefficients and/or generation of syntax information such as coded block pattern (CBP) values, macroblock type, coding mode, maximum macroblock size for a coded unit (such as a frame, slice, macroblock, or sequence), or the like.

A video encoder may further send syntax data, such as block-based syntax data, frame-based syntax data, and/or GOP-based syntax data, to a video decoder, e.g., in a frame header, a block header, a slice header, or a GOP header. The GOP syntax data may describe a number of frames in the respective GOP, and the frame syntax data may indicate an encoding/prediction mode used to encode the corresponding frame.

In H.264/AVC, the coded video bits are organized into Network Abstraction Layer (NAL) units, which provide a “network-friendly” video representation addressing the applications such as video telephony, storage, broadcast, or streaming. NAL units can be categorized to Video Coding Layer (VCL) NAL units and non-VCL NAL units. VCL units contain the core compression engine and comprise block, MB and slice levels. Other NAL units are non-VCL NAL units.

Each NAL unit contains a 1 byte NAL unit header. Five bits are used to specify the NAL unit type and three bits are used for nal_ref_idc, indicating how important the NAL unit is in terms of being referenced by other pictures (NAL units). This value equal to 0 means that the NAL unit is not used for inter-prediction.

Parameter sets contain the sequence-level header information in sequence parameter sets (SPS) and the infrequently changing picture-level header information in picture parameter sets (PPS). With parameter sets, this infrequently changing information does not need to be repeated for each sequence or picture, hence coding efficiency is improved. Furthermore, the use of parameter sets enables out-of-band transmission of header information, avoiding the need of redundant transmissions for error resilience. In out-of-band transmission, parameter set NAL units may be transmitted on a different channel than the other NAL units.

In MVC, inter-view prediction is supported by disparity compensation, which uses the syntax of the H.264/AVC motion compensation, but allows a picture in a different view to be used as a reference picture. That is, pictures in MVC may be inter-view predicted and coded. Disparity vectors may be used for inter-view prediction, in a manner similar to motion vectors in temporal prediction. However, rather than providing an indication of motion, disparity vectors indicate offset of data in a predicted block relative to a reference frame of a different view, to account for the horizontal offset of the camera perspective of the common scene. In this manner, a motion compensation unit may perform disparity compensation for inter-view prediction.

As mentioned above, H.264/AVC, a NAL unit consists of a 1-byte header and a payload of varying size. In MVC, this structure is retained except for prefix NAL units and MVC coded slice NAL units, which consist of a 4-byte header and the NAL unit payload. Syntax elements in MVC NAL unit header include priority_id, temporal_id, anchor_pic_flag, view_id, non_idr_flag and inter_view_flag.

The anchor_pic_flag syntax element indicates whether a picture is an anchor picture or non-anchor picture. Anchor pictures and all the pictures succeeding it in the output order (i.e. display order) can be correctly decoded without decoding of previous pictures in the decoding order (i.e. bitstream order) and thus can be used as random access points. Anchor pictures and non-anchor pictures can have different dependencies, both of which are signaled in the sequence parameter set.

The bitstream structure defined in MVC is characterized by two syntax elements: view_id and temporal_id. The syntax element view_id indicates the identifier of each view. This indication in NAL unit header enables easy identification of NAL units at the decoder and quick access of the decoded views for display. The syntax element temporal_id indicates the temporal scalability hierarchy or, indirectly, the frame rate. An operation point including NAL units with a smaller maximum temporal_id value has a lower frame rate than an operation point with a larger maximum temporal_id value. Coded pictures with a higher temporal_id value typically depend on the coded pictures with lower temporal_id values within a view, but not on any coded picture with a higher temporal_id.

The syntax elements view_id and temporal_id in the NAL unit header are used for both bitstream extraction and adaptation. Another syntax element in the NAL unit header is priority_id, which is used for the simple one-path bitstream adaptation process. That is, a device receiving or retrieving the bitstream may use the priority_id value to determine priorities among the NAL units when performing bitstream extraction and adaptation, which allows one bitstream to be sent to multiple destination devices with varying coding and rendering capabilities.

The inter_view_flag syntax element indicates whether the NAL unit will be used for inter-view predicting another NAL unit in a different view.

In MVC, the view dependency is signaled in the SPS MVC extension. All inter-view prediction is done within the scope specified by the SPS MVC extension. View dependency indicates whether a view is dependent on another view, e.g., for inter-view prediction. Where a first view is predicted from data of a second view, the first view is said to be dependent on the second view. Table 1 below represents an example of the MVC extension for the SPS.

TABLE 1

| | C | Descriptor |
|---|---|---|
| seq_parameter_set_mvc_extension( ) { | | |
| num_views_minus1 | 0 | ue(v) |

for( i = 0; i <= num_views_minus1; i++ )

| | | |
|---|---|---|
| view_id[ i ] | 0 | ue(v) |

for( i = 1; i <= num_views_minus1; i++ ) {

| | | |
|---|---|---|
| num_anchor_refs_l0[ i ] | 0 | ue(v) |
| for( j = 0; j < num_anchor_refs_l0[ i ]; j++ ) | | |

| | | |
|---|---|---|
| anchor_ref_l0[ i ][ j ] | 0 | ue(v) |

| | | |
|---|---|---|
| num_anchor_refs_l1[ i ] | 0 | ue(v) |
| for( j = 0; j < num_anchor_refs_l1[ i ]; j++ ) | | |

| | | |
|---|---|---|
| anchor_ref_l1[ i ][ j ] | 0 | ue(v) |

}
for( i = 1; i <= num_views_minus1; i++ ) {

| | | |
|---|---|---|
| num_non_anchor_refs_l0[ i ] | 0 | ue(v) |
| for( j = 0; j < num_non_anchor_refs_l0[ i ]; j++ ) | | |

| | | |
|---|---|---|
| non_anchor_ref_l0[ i ][ j ] | 0 | ue(v) |

| | | |
|---|---|---|
| num_non_anchor_refs_l1[i] | 0 | ue(v) |
| for( j = 0; j < num_non_anchor_refs_l1[ i ]; j++ ) | | |

| | | |
|---|---|---|
| non_anchor_ref_l1[ i ][ j ] | 0 | ue(v) |

| | | |
|---|---|---|
| } | | |
| num_level_values_signalled_minus1 | 0 | ue(v) |
| for(i = 0; i<= num_level_values_signalled_minus1; i++) { | | |

| | | |
|---|---|---|
| level_idc[ i ] | 0 | u(8) |
| num_applicable_ops_minus1[ i ] | 0 | ue(v) |
| for( j = 0; j <= num_applicable_ops_minus1[ i ]; j++ ) { | | |

| | | |
|---|---|---|
| applicable_op_temporal_id[ i ][ j ] | 0 | u(3) |
| applicable_op_num_target_views_minus1[ i ][ j ] | 0 | ue(v) |
| for( k = 0; k <= | | |

applicable_op_num_target_views_minus1[ i ][ j ]; k++ )

| | | |
|---|---|---|
| applicable_op_target_view_id[ i ][ j ][ k ] | 0 | ue(v) |

| | | |
|---|---|---|
| applicable_op_num_views_minus1[ i ][ j ] | 0 | ue(v) |

}

}

}

To take advantages of the most start-of-the-art 3D video coding tools, extra implementations or new system structures are used with a 3D video codec compared to a traditional 2D video codec. However, a backward-compatible solution to deliver stereoscopic 3D content called frame-compatible coding may be used. In frame-compatible coding, stereoscopic video content could be decoded using the existing 2D video codec. In frame-compatible stereoscopic video coding, a single decoded video frame contains stereoscopic left and right views, e.g., in side-by-side or top-down formats, but with half of the original vertical or horizontal resolution.

The frame-compatible stereoscopic 3D video coding can be realized based on the H.264/AVC codec with the adoption of a supplemental enhancement information (SEI) message that indicates the frame packing arrangement used. Different frame packing types are supported by this SEI, such as side-by-side and top-down.

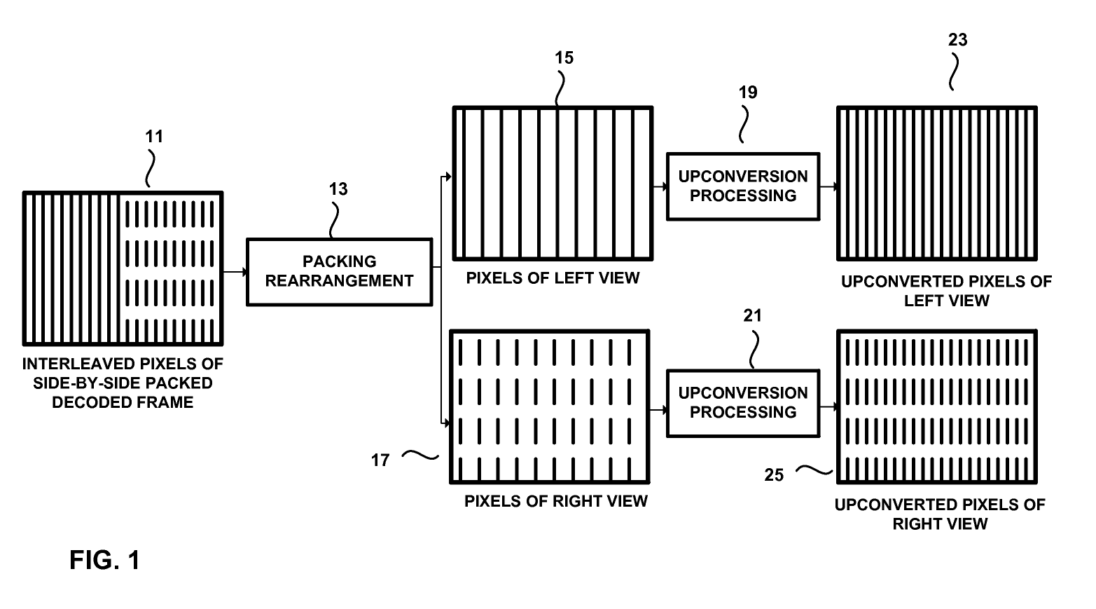

FIG. 1 is a conceptual diagram showing an example process for frame-compatible stereoscopic video coding using a side-by-side frame packing arrangement. In particular, FIG. 1 shows the process for rearranging pixels for a decoded frame of frame-compatible stereoscopic video data. The decoded frame 11 consists of interleaved pixels that are packed in a side-by-side arrangement. A side-by-side arrangement consists of pixels for each view (in this example a left view and a right view) being arranged in columns. As one alternative, a top-down packing arrangement would arrange pixels for each view in rows. The decoded frame 11 depicts pixels of the left view as solid lines and the pixels of the right view as dashed lines. The decoded frame 11 may also be referred to as an interleaved frame, in that decoded frame 11 includes side-by-side interleaved pixels.

The packing arrangement unit 13 splits the pixels in the decoded frame 11 into a left view frame 15 and a right view frame 17 according to the packing arrangement signaled by an encoder, such as in an SEI message. As can be seen, each of the left and right view frames are at half resolution as they contain only every other column of pixels for the size of the frame.

The left view frame 15 and the right view frame 17 are then upconverted by the upconversion processing units 19 and 21, respectively, to produce an upconverted left view frame 23 and an upconverted right view frame 25. The upconverted left view frame 23 and the upconverted right view frame 25 may then be displayed by a stereoscopic display.

While the process for frame-compatible stereoscopic video coding allows the use of existing 2D codecs, upconverting half-resolution video frames may not deliver desired video quality, particularly for high-definition video applications. By utilizing the scalable features of H.264/SVC, additional half resolution frames may be sent in an enhancement layer so that a 2D decoder may be used to produce a full resolution stereoscopic image. The base layer may be arranged in the same manner as the frame-compatible stereoscopic video shown in FIG. 1. The enhancement layer may contain the remaining half-resolution video information to provide for a full resolution representation of both left and right views. Such an enhancement layer can be realized by introducing a non-base view in the MVC codec. This process is often called full resolution frame-compatible stereoscopic video coding. In this manner, a process similar to that of FIG. 1 may be used to decode packed frames, which may then be filtered, in accordance with the techniques of this disclosure. Moreover, in cases where the enhancement layer is not received, the base layer may provide acceptable quality for upsampling without loss of continuity during playback. Thus, the filtering techniques of this disclosure may be adaptively applied based on whether the enhancement layer frame is received or not.

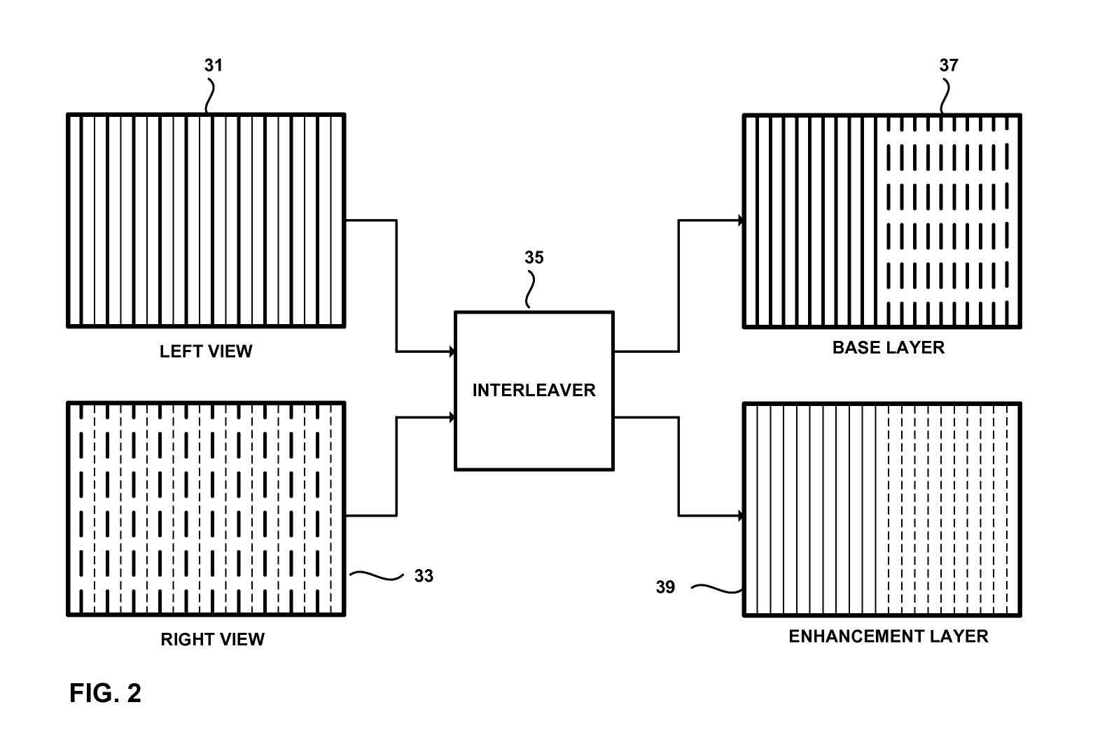

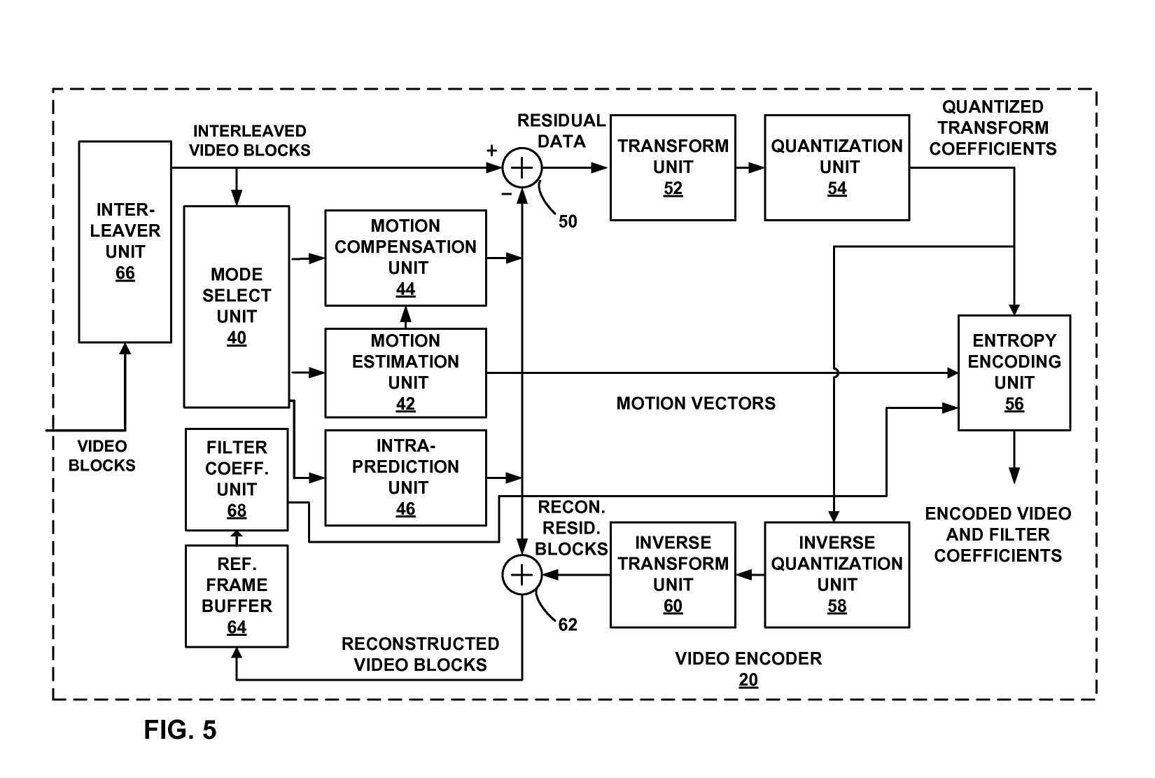

FIG. 2 is a conceptual diagram illustrating one example of an encoding process in full resolution frame-compatible stereoscopic video coding. A frame-compatible base layer 37 is created by interleaving a half-resolution portion of the left view 31 with a half resolution portion of the right view 22 using an interleaver unit 35. An enhancement layer 39 is also created by interleaving the “complementary” half-resolution portion of the left view 31 and the “complementary’ half-resolution portion of the right view 33. In the example shown in FIG. 2, the base layer consists of the odd-numbered columns of pixels from the left and right view, while the enhancement layer consists of the even-numbered columns (i.e., the complementary columns to the columns used in the base layer) from the left and right view. The packing arrangement shown in FIG. 2 is called a side-by-side packing arrangement. However, other packing arrangements may be implemented, including a top-down packing arrangement where half-resolution frames consist of rows of pixels from the left and right view, as well as quincunx or “checkerboard” packing that resembles a checkerboard, where alternate pixels in both rows and columns correspond to the left or right view. Interleaver 35, or a unit similar thereto, may form part of an encoder, such as video encoder 20, as discussed in greater detail with respect to FIG. 5, below.

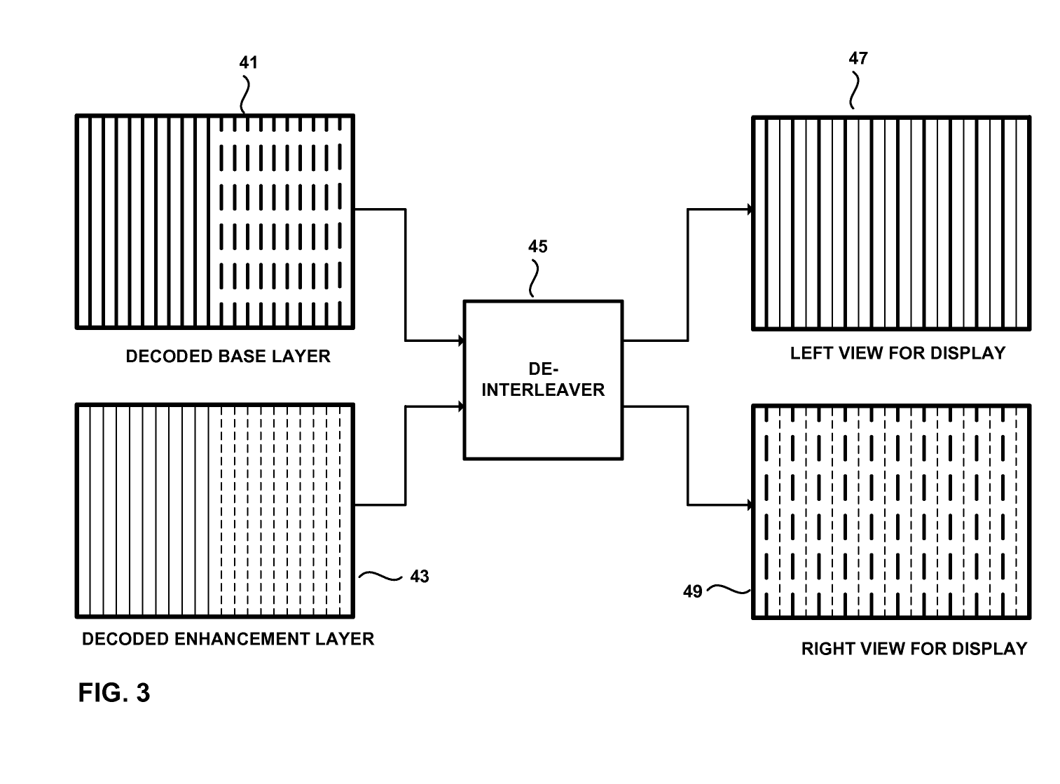

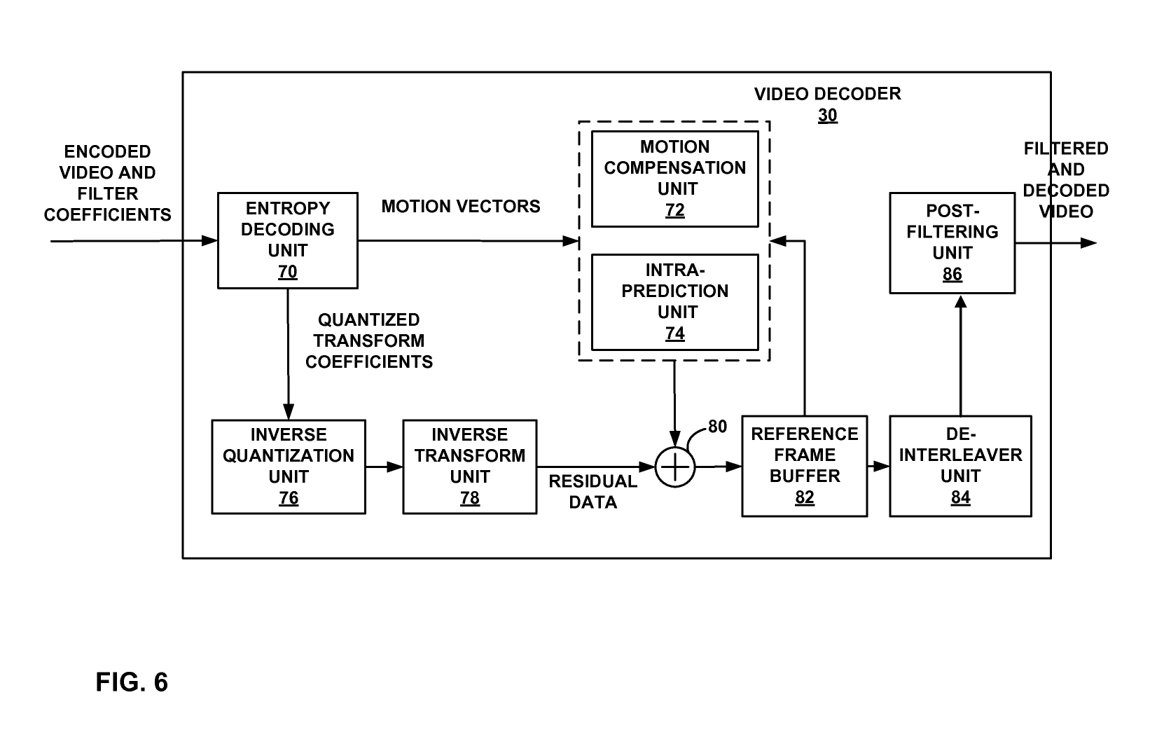

FIG. 3 is a conceptual diagram illustrating one example of a decoding process in full resolution frame-compatible stereoscopic video coding. FIG. 3 shows the last stages of a decoding process where each of the base layer and enhancement layer have been decoded. The decoded base layer 41 includes half-resolution images of a left view and a right view picture arranged in a side-by-side arrangement. The decoded base layer 41 corresponds to the example base layer 37 of FIG. 2. The decoded enhancement layer 43 includes complementary half-resolution images of a left view and a right view picture arranged in a side-by-side arrangement. The decoded enhancement layer 43 corresponds to the example enhancement layer 39 of FIG. 2. To reproduce the original full resolution left and right views, the decoded base layer 41 and decoded enhancement layer 43 are de-interleaved using de-interleaver unit 45. De-interleaver unit 45, or a unit similar thereto, may form part of a decoder, such as video decoder 30 as discussed in greater detail with respect to FIG. 6, below. The de-interleaver unit 45 rearranges the columns of pixels in the decoded base layer and enhancement layer to produce a left view frame 47 and a right view frame 49 that then may be displayed. Contrary to the example of FIG. 1, there is no need for an upconversion process in full resolution frame-compatible stereoscopic video coding as the enhancement layer contains the “complementary” half-resolution image to the half-resolution image in the base layer. As such, higher quality stereoscopic video may be coded using 2D codecs configured for H.264/SVC operation.

One drawback to the interleaving approach in full resolution frame-compatible stereoscopic video coding is that such a process typically causes aliasing. As such, anti-aliasing down-sampling filters may be used. Similarly, the complementary pixels in the non-base view (e.g., the enhancement layer) are not necessarily the remaining pixels (e.g., the other half-resolution view) as shown in FIG. 2. However, since the complementary signals in the non-base view are not output directly, the filter to generate the non-base view can be designed in a way that the quality of final full-resolution stereoscopic video is optimized.

De-interleaving the reconstructed frame-compatible left and right views from the base layer and enhancement layer may cause other video quality issues. Undesirable video artifacts, such as spatial quality inconsistency across rows or columns, may be present. Such spatial inequality may exist because the decoded base view and decoded enhancement view may have different types and levels of coding distortions because the encoding process used for the base and enhancement layer may utilize different prediction modes, quantization parameters, partition sizes, or may be sent at different bit rates.

In view of these drawbacks, the present disclosure proposes techniques for post-filtering decoded stereoscopic video data according to left view and right view filters. In one example, two sets of filter coefficients for each view (i.e., the left and right view) are used to filter decoded stereoscopic video data that was previously encoded according to a full resolution frame-compatible stereoscopic video coding process. Other examples of the disclosure describe techniques for generating the filter coefficients for the left view and right view filters.

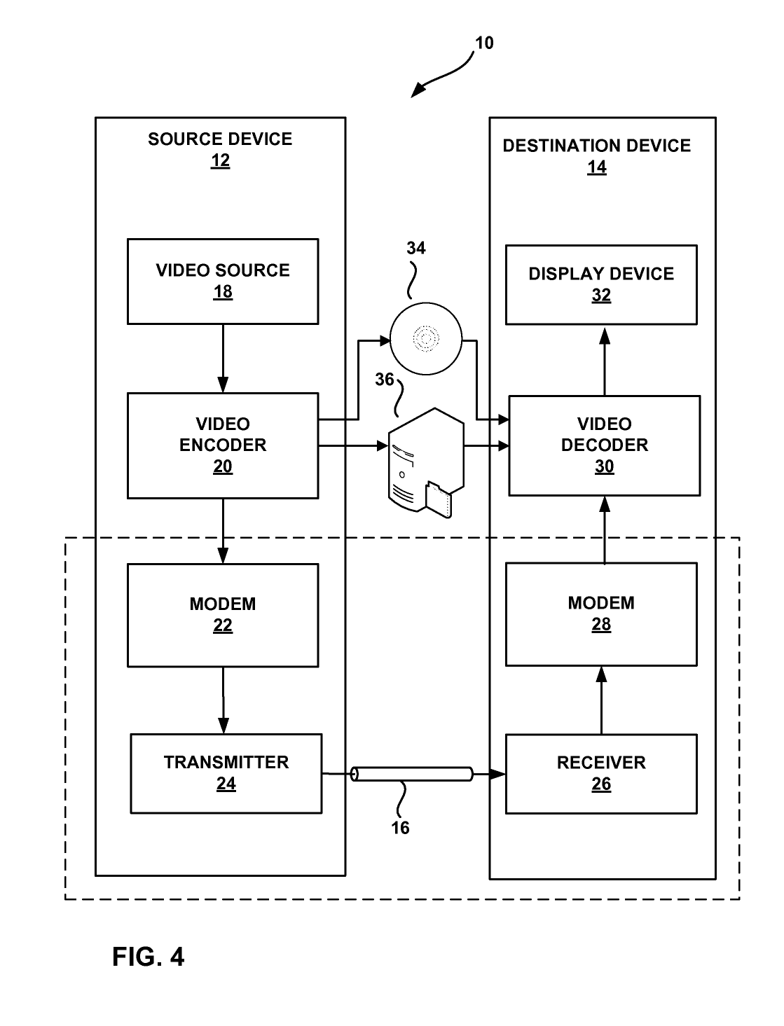

FIG. 4 is a block diagram illustrating an example video encoding and decoding system 10 that may be configured to utilize techniques for coding and processing stereoscopic video data in accordance with examples of this disclosure. As shown in FIG. 4, the system 10 includes a source device 12 that transmits encoded video to a destination device 14 via a communication channel 16. Encoded video data may also be stored on a storage medium 34 or a file server 36 and may be accessed by the destination device 14 as desired. When stored to a storage medium or file server, video encoder 20 may provide coded video data to another device, such as a network interface, a compact disc (CD), Blu-ray or digital video disc (DVD) burner or stamping facility device, or other devices, for storing the coded video data to the storage medium. Likewise, a device separate from video decoder 30, such as a network interface, CD or DVD reader, or the like, may retrieve coded video data from a storage medium and provided the retrieved data to video decoder 30.

The source device 12 and the destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wireless communication. Hence, the communication channel 16 may comprise a wireless channel, a wired channel, or a combination of wireless and wired channels suitable for transmission of encoded video data. Similarly, the file server 36 may be accessed by the destination device 14 through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server.

Techniques for coding and processing stereoscopic video data, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, the system 10 may be configured to support one-way or two-way video transmission to support applications such as video streaming, video playback, video broadcasting, and/or video telephony.

In the example of FIG. 4, the source device 12 includes a video source 18, a video encoder 20, a modulator/demodulator 22 and a transmitter 24. In the source device 12, the video source 18 may include a source such as a video capture device, such as a video camera, a video archive containing previously captured video, a video feed interface to receive video from a video content provider, and/or a computer graphics system for generating computer graphics data as the source video, or a combination of such sources. As one example, if the video source 18 is a video camera, the source device 12 and the destination device 14 may form so-called camera phones or video phones. In particular, the video source 18 may be any device configured to produce stereoscopic video data consisting of two or more views (e.g., a left view and a right view). However, the techniques described in this disclosure may be applicable to video coding in general, and may be applied to wireless and/or wired applications, or application in which encoded video data is stored on a local disk.

The captured, pre-captured, or computer-generated video may be encoded by the video encoder 20. The encoded video information may be modulated by the modem 22 according to a communication standard, such as a wireless communication protocol, and transmitted to the destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The captured, pre-captured, or computer-generated video that is encoded by the video encoder 20 may also be stored onto a storage medium 34 or a file server 36 for later consumption. The storage medium 34 may include Blu-ray discs, DVDs, CD-ROMs, flash memory, or any other suitable digital storage media for storing encoded video. The encoded video stored on the storage medium 34 may then be accessed by the destination device 14 for decoding and playback.

The file server 36 may be any type of server capable of storing encoded video and transmitting that encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 36 may be a streaming transmission, a download transmission, or a combination of both. The file server 36 may be accessed by the destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on a file server.

The destination device 14, in the example of FIG. 4, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on the storage medium 34 or the file server 36. Each of the video encoder 20 and the video decoder 30 may form part of a respective encoder-decoder (CODEC) that is capable of encoding or decoding video data.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

In one example, the display device 14 may be a stereoscopic display capable of displaying two or more views to produce a three-dimensional effect. To produce a three-dimensional effect in video, two views of a scene, e.g., a left eye view and a right eye view may be shown simultaneously or nearly simultaneously. Two pictures of the same scene, corresponding to the left eye view and the right eye view of the scene, may be captured from slightly different horizontal positions, representing the horizontal disparity between a viewer's left and right eyes. By displaying these two pictures simultaneously or nearly simultaneously, such that the left eye view picture is perceived by the viewer's left eye and the right eye view picture is perceived by the viewer's right eye, the viewer may experience a three-dimensional video effect.

A user may wear active glasses to rapidly and alternatively shutter left and right lenses, such that display device 32 may rapidly switch between the left and the right view in synchronization with the active glasses. Alternatively, display device 32 may display the two views simultaneously, and the user may wear passive glasses (e.g., with polarized lenses) which filter the views to cause the proper views to pass through to the user's eyes. As still another example, display device 32 may comprise an autostereoscopic display, for which no glasses are needed.

In the example of FIG. 4, the communication channel 16 may comprise any wireless or wired communication medium, such as a radio frequency (RF) spectrum or one or more physical transmission lines, or any combination of wireless and wired media. The communication channel 16 may form part of a packet-based network, such as a local area network, a wide-area network, or a global network such as the Internet. The communication channel 16 generally represents any suitable communication medium, or collection of different communication media, for transmitting video data from the source device 12 to the destination device 14, including any suitable combination of wired or wireless media. The communication channel 16 may include routers, switches, base stations, or any other equipment that may be useful to facilitate communication from the source device 12 to the destination device 14.

The video encoder 20 and the video decoder 30 may operate according to a video compression standard, such as the ITU-T H.264 standard, alternatively referred to as MPEG-4, Part 10, Advanced Video Coding (AVC). The video encoder 20 and the video decoder 30 may also operate according to the MVC or SVC extensions of H.264/AVC. Alternatively, the video encoder 20 and the video encoder 30 may operate according to the High Efficiency Video Coding (HEVC) standard presently under development, and may conform to the HEVC Test Model (HM). The techniques of this disclosure, however, are not limited to any particular coding standard. Other examples include MPEG-2 and ITU-T H.263.

Although not shown in FIG. 4, in some aspects, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

The video encoder 20 may implement any or all of the techniques of this disclosure for coding and processing stereoscopic video data in a video encoding process. Likewise, the video decoder 30 may implement any or all of these coding and processing stereoscopic video data in a video coding process. A video coder, as described in this disclosure, may refer to a video encoder or a video decoder. Similarly, a video coding unit may refer to a video encoder or a video decoder. Likewise, video coding may refer to video encoding or video decoding.

In one example of the disclosure, the video encoder 20 of the source device 12 may be configured to encode a left view picture and a right view picture to form an encoded picture, decode the encoded picture to form a decoded left view picture and a decoded right view picture, generate left view filter coefficients based on a comparison of the left view picture and the decoded left view picture, and generate right view filter coefficients based on a comparison of the right view picture and the decoded right view picture.

In another example of the disclosure, the video decoder 30 of the destination device 14 may be configured to de-interleave a decoded picture to form a decoded left view picture and a decoded right view picture, wherein the decoded picture includes a first portion of a left view picture, a first portion of a right view picture, a second portion of a left view picture, and a second portion of a right view picture, apply a first left-view specific filter to pixels of the decoded left view picture and apply a second left-view specific filter to pixels of the decoded left view picture to form a filtered left view picture, apply a first right-view specific filter to pixels of the decoded right view picture and apply a second right-view specific filter to pixels of the decoded right view picture to form a filtered right view picture, and output the filtered left view picture and the filtered right view picture to cause a display device to display three-dimensional video comprising the filtered left view picture and the filtered right view picture.

FIG. 5 is a block diagram illustrating an example of a video encoder 20 that may use techniques for coding and processing stereoscopic video data as described in this disclosure. The video encoder 20 will be described in the context of the H.264 video coding standard for purposes of illustration, but without limitation of this disclosure as to other coding standards or methods that may utilize techniques for generating filter coefficients for coding and processing stereoscopic video data. In examples of this disclosure, the video encoder 20 may further be configured to utilize techniques of the H.264 SVC and MVC extension to perform a full resolution frame-compatible stereoscopic video coding process.

With respect to FIG. 5, and elsewhere in this disclosure, the video encoder 20 is described as encoding one or more frames or blocks of video data. As described above, a layer (e.g., the base layer and enhancement layers) may include a series of frames that make up multimedia content. Thus, a “base frame” may refer to a single frame of video data in the base layer. In addition, an “enhancement frame” may refer to a single frame of video data in an enhancement layer.

Generally, the video encoder 20 may perform intra- and inter-coding of blocks within video frames, including macroblocks, or partitions or sub-partitions of macroblocks. Intra-coding relies on spatial prediction to reduce or remove spatial redundancy in video within a given video frame. Intra-mode (I-mode) may refer to any of several spatial based compression modes and inter-modes such as uni-directional prediction (P-mode) or bi-directional prediction (B-mode) may refer to any of several temporal-based compression modes. Inter-coding relies on temporal prediction to reduce or remove temporal redundancy in video within adjacent frames of a video sequence.

The video encoder 20 may also, in some examples, be configured to perform inter-view prediction and inter-layer prediction of the base or enhancement layers. For example, video encoder 20 may be configured to perform inter-view prediction in accordance with the multi-view video coding (MVC) extension of H.264/AVC. In addition, the video encoder 20 may be configured to perform inter-layer prediction in accordance with the scalable video coding (SVC) extension of H.264/AVC. Accordingly, the enhancement layer may be inter-view predicted or inter-layer predicted from the base layer. In such cases, motion estimation unit 42 may additionally be configured to perform disparity estimation relative to a corresponding (that is, temporally co-located) picture of a different view, and motion compensation unit 44 may be additionally configured to perform disparity compensation using a disparity vector calculated by motion estimation unit 42. Moreover, motion estimation unit 42 may be referred to as a “motion/disparity estimation unit” and motion compensation unit 44 may be referred to as a “motion/disparity compensation unit.”

As shown in FIG. 5, the video encoder 20 receives video blocks within a video frame to be encoded. In the example of FIG. 5, the video encoder 20 includes a motion compensation unit 44, a motion estimation unit 42, an intra-prediction unit 46, a reference frame buffer 64, a summer 50, a transform unit 52, a quantization unit 54, an entropy encoding unit 56, a filter coefficient unit 68, and an interleaver unit 66. The transform unit 52 illustrated in FIG. 5 is the unit that applies the actual transform or combinations of transform to a block of residual data, and is not to be confused with block of transform coefficients, which also may be referred to as a transform unit (TU) of a CU. For video block reconstruction, the video encoder 20 also includes an inverse quantization unit 58, an inverse transform unit 60, and a summer 62. A deblocking filter (not shown in FIG. 5) may also be included to filter block boundaries to remove blockiness artifacts from reconstructed video. If desired, the deblocking filter would typically filter the output of the summer 62.

During the encoding process, the video encoder 20 receives a video frame or slice to be coded. The frame or slice may be divided into multiple video blocks, e.g., largest coding units (LCUs). The motion estimation unit 42 and the motion compensation unit 44 perform inter-predictive coding of the received video block relative to one or more blocks in one or more reference frames to provide temporal prediction. The intra-prediction unit 46 may perform intra-predictive coding of the received video block relative to one or more neighboring blocks in the same frame or slice as the block to be coded to provide spatial prediction.

In one example of this disclosure, the video encoder 20 may receive two or more blocks or frames of stereoscopic video. For example, the video encoder may receive a frame video data of a left view 31 and a frame of video data of right view 33, as depicted in FIG. 2 The interleaver unit 66 may interleave the left view frame and the right view frame into a base layer and an enhancement. As one example, the interleaver unit 66 may interleave the right view and left view using a side-by-side packing process as depicted in FIG. 2. In this example, the base layer is packed with a half resolution version of the left view (e.g., the odd columns of pixels) and a half resolution version of the right view (e.g., the odd columns of pixels). The enhancement layer would then be packed with a complementary half resolution version of the left view (e.g., the even columns of pixels) and a half resolution version of the right view (e.g., the even columns of pixels). It should be noted that a side-by-side packing arrangement as shown in FIG. 2 is just one example. Other packing arrangements may be used, such as top-down or checkerboard packing arrangements, where the base layer contains partial resolution versions of the left and right views, while the enhancement layer contains complementary partial resolution versions. The partial resolution versions are configured such that, when combined with the partial resolution versions in the base layer, can recreate a full resolution version of both the left and right views. In other examples, the functionality attributed to interleaver unit 66 may be performed by a pre-processing unit external to video encoder 20.

The following description describes the encoding process used for both the interleaved base layer and the interleaved enhancement layer created by the interleaver unit 66. The encoding of these two layers may be conducted serially or in parallel. For ease of discussion, a reference to a “block” or “video block” generally refers to a block of data in a base layer or enhancement layer unless such layers are referred to specifically.

The mode select unit 40 may select one of the coding modes for interleaved video blocks. The coding modes may be intra or inter prediction, e.g., based on error (i.e., distortion) results for each mode, and provides the resulting intra- or inter-predicted block (e.g., a prediction unit (PU)) to the summer 50 to generate residual block data and to the summer 62 to reconstruct the encoded block for use in a reference frame. Summer 62 combines the predicted block with inverse quantized, inverse transformed data from inverse transform unit 60 for the block to reconstruct the encoded block, as described in greater detail below. Some video frames may be designated as I-frames, where all blocks in an I-frame are encoded in an intra-prediction mode. In some cases, the intra-prediction unit 46 may perform intra-prediction encoding of a block in a P- or B-frame, e.g., when motion search performed by the motion estimation unit 42 does not result in a sufficient prediction of the block.

The motion estimation unit 42 and the motion compensation unit 44 may be highly integrated, but are illustrated separately for conceptual purposes. Motion estimation (or motion search) is the process of generating motion vectors, which estimate motion for video blocks. A motion vector, for example, may indicate the displacement of a prediction unit in a current frame relative to a reference sample of a reference frame. The motion estimation unit 42 calculates a motion vector for a prediction unit of an inter-coded frame by comparing the prediction unit to reference samples of a reference frame stored in the reference frame buffer 64. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

The motion estimation unit 42 sends the calculated motion vector to the entropy encoding unit 56 and the motion compensation unit 44. The portion of the reference frame identified by a motion vector may be referred to as a reference sample. The motion compensation unit 44 may calculate a prediction value for a prediction unit of a current CU, e.g., by retrieving the reference sample identified by a motion vector for the PU.

The intra-prediction unit 46 may intra-predict the received block, as an alternative to inter-prediction performed by the motion estimation unit 42 and the motion compensation unit 44. The intra-prediction unit 46 may predict the received block relative to neighboring, previously coded blocks, e.g., blocks above, above and to the right, above and to the left, or to the left of the current block, assuming a left-to-right, top-to-bottom encoding order for blocks. The intra-prediction unit 46 may be configured with a variety of different intra-prediction modes. For example, the intra-prediction unit 46 may be configured with a certain number of directional prediction modes, e.g., thirty-four directional prediction modes, based on the size of the CU being encoded.

The intra-prediction unit 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, the intra-prediction unit 46 may calculate an error value for the prediction mode based on pixel differences between the PU and the received block to be encoded. The intra-prediction unit 46 may continue testing intra-prediction modes until an intra-prediction mode that yields an acceptable error value is discovered. The intra-prediction unit 46 may then send the PU to the summer 50.

The video encoder 20 forms a residual block by subtracting the prediction data calculated by the motion compensation unit 44 or the intra-prediction unit 46 from the original video block being coded. The summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded.

The transform unit 52 may form one or more transform units (TUs) from the residual block. The transform unit 52 selects a transform from among a plurality of transforms. The transform may be selected based on one or more coding characteristics, such as block size, coding mode, or the like. The transform unit 52 then applies the selected transform to the TU, producing a video block comprising a two-dimensional array of transform coefficients.

The transform unit 52 may send the resulting transform coefficients to the quantization unit 54. The quantization unit 54 may then quantize the transform coefficients. The entropy encoding unit 56 may then perform a scan of the quantized transform coefficients in the matrix according to a scanning mode. This disclosure describes the entropy encoding unit 56 as performing the scan. However, it should be understood that, in other examples, other processing units, such as the quantization unit 54, could perform the scan.

Once the transform coefficients are scanned into the one-dimensional array, the entropy encoding unit 56 may apply entropy coding such as CAVLC, CABAC, syntax-based context-adaptive binary arithmetic coding (SBAC), or another entropy coding methodology to the coefficients.

To perform CAVLC, the entropy encoding unit 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted.

To perform CABAC, the entropy encoding unit 56 may select a context model to apply to a certain context to encode symbols to be transmitted. The context may relate to, for example, whether neighboring values are non-zero or not. The entropy encoding unit 56 may also entropy encode syntax elements, such as the signal representative of the selected transform. In accordance with the techniques of this disclosure, the entropy encoding unit 56 may select the context model used to encode these syntax elements based on, for example, an intra-prediction direction for intra-prediction modes, a scan position of the coefficient corresponding to the syntax elements, block type, and/or transform type, among other factors used for context model selection.

Following the entropy coding by the entropy encoding unit 56, the resulting encoded video may be transmitted to another device, such as the video decoder 30, or archived for later transmission or retrieval.

In some cases, the entropy encoding unit 56 or another unit of the video encoder 20 may be configured to perform other coding functions, in addition to entropy coding. For example, the entropy encoding unit 56 may be configured to determine coded block pattern (CBP) values for CU's and PU's. Also, in some cases, the entropy encoding unit 56 may perform run length coding of coefficients.

The inverse quantization unit 58 and the inverse transform unit 60 apply inverse quantization and inverse transformation, respectively, to reconstruct the residual block in the pixel domain, e.g., for later use as a reference block. The motion compensation unit 44 may calculate a reference block by adding the residual block to a predictive block of one of the frames of the reference frame buffer 64. The motion compensation unit 44 may also apply one or more interpolation filters to the reconstructed residual block to calculate sub-integer pixel values for use in motion estimation. The summer 62 adds the reconstructed residual block to the motion compensated prediction block produced by the motion compensation unit 44 to produce a reconstructed video block for storage in the reference frame buffer 64. The reconstructed video block may be used by the motion estimation unit 42 and the motion compensation unit 44 as a reference block to inter-code a block in a subsequent video frame.

According to examples of this disclosure, the reconstructed video blocks (i.e., the reconstructed base layer and enhancement layer) may be used to generate filter coefficients for use in a post-filtering process by a video filter or video decoder, such as the video decoder 30 of FIG. 4. As discussed below, filter coefficient unit 68 may be configured to generate these filter coefficients. The filter coefficient generation and post-filtering process may be used to improve video quality due to potential spatial inequality of the decoded video. Such spatial inequality may exist because the reconstructed base layer and enhancement layer may have different types and levels of coding distortions because the coding processes for the base and enhancement layer, as described above, may utilize different prediction modes, quantization parameters, partition sizes, or may be sent at different bit rates.

The filter coefficient unit 68 may retrieve the reconstructed base layer and enhancement layer from the reference frame buffer 64. The filter coefficient unit then de-interleaves the reconstructed base layer and enhancement layers to reconstruct a left view and a right view. The de-interleaving process may be the same as described above with reference to FIG. 3. The reference frame buffer 64 may also store the original left view and right view frames existed prior to encoding.

The filter coefficient unit 68 is configured to generate two sets of filter coefficients. One set of filter coefficients is for use on the left view and another set of filter coefficients is for use on the decoded right view. The two sets of filter coefficients are estimated by the filter coefficient unit 66 by minimizing the mean squared error between a filtered version of the left and right views and the original left and right views as follows:

$$\begin{matrix}{H}_{1} = {argmin}_{{H}_{1}} ( E [ {( {x}_{L , ( 2 i , i )}^{″} - {x}_{L , ( 2 i , i )} )}^{2} ] ) & ( 1 ) \\ {H}_{2} = {argmin}_{{H}_{2}} ( E [ {( {x}_{L , ( 2 i + 1 , j )}^{″} - {x}_{L , ( 2 i + 1 , j )} )}^{2} ] ) & ( 2 ) \\ {G}_{1} = {argmin}_{{G}_{1}} ( E [ {( {x}_{R , ( 2 i , j )}^{″} - {x}_{R , ( 2 i , j )} )}^{2} ] ) & ( 3 ) \\ {G}_{2} = {argmin}_{{G}_{2}} ( E [ {( {x}_{R , ( 2 i + 1 , j )}^{″} - {x}_{R , ( 2 i + 1 , j )} )}^{2} ] ) & ( 4 )\end{matrix}$$

X″_{L,(2i,j)} represents the even column pixels of the filtered left view. X_{L,(2i,j)} represents the even column pixels of the original left view. X″_{L,(2i+1,j)} represents the odd column pixels of the filtered left view. X_{L,(2i+1,j)} represents the odd column pixels of the original left view. X″_{R,(2i,j)} represents the even column pixels of the filtered right view. X_{R,(2i,j)} represents the even column pixels of the original right view X″_{R,(2i+1,j)} represents the odd column pixels of the filtered right view. X_{R,(2i+1,j)} represents the odd column pixels of the original right view. H₁ and G₁ are filter coefficients that minimize the mean squared error between the filtered even-column pixels and the original even-column pixels for the left and right view respectively, and H₂ and G₂ are filter coefficients that minimize the mean squared error between the filtered odd-column pixels and the original odd-column pixels for left and right view respectively. The sets of filter coefficients are different for the odd columns and even columns are different, as this is the example interleaving packing process described in the example of FIG. 5. The sets of filter coefficients may, for example, apply to odd and even rows of pixels of the left and right views if a top-down packing method was used.

In an alternative example, the same set of filters may be applied for both left and right views, i.e., H₁=G₁ and H₂=G₂. In this example, filter coefficient unit 68 may be configured to estimate the filter coefficients by minimizing the mean square error of the following terms:

$$\begin{matrix}{H}_{1} = {argmin}_{{H}_{1}} ( E [ {( {x}_{L , ( 2 i , j )}^{″} - {x}_{L , ( 2 i , j )} )}^{2} ] + E [ {( {x}_{R , ( 2 i , j )}^{″} - {x}_{R , ( 2 i , j )} )}^{2} ] ) & ( 5 ) \\ {H}_{2} = {argmin}_{{H}_{2}} ( E [ {( {x}_{L , ( 2 i + 1 , j )}^{″} - {x}_{L , ( 2 i + 1 , j )} )}^{2} ] + E [ {( {x}_{R , ( 2 i + 1 , j )}^{″} - {x}_{R , ( 2 i + 1 j )} )}^{2} ] ) & ( 6 )\end{matrix}$$

H₁ is obtained by minimizing the even-column mean squared error for both left and right views and H₂ is obtained by minimizing the odd-column mean squared error for both left and right views.

The estimated filter coefficients may then be signaled in the encoded video bitstream. In this context, signaling the filter coefficients in the encoded bitstream does not require real-time transmission of such elements from the encoder to a decoder, but rather means that such filter coefficients are encoded into the bitstream and are made accessible to the decoder in any fashion. This may include real-time transmission (e.g., in video conferencing) as well as storing the encoded bitstream on a computer-readable medium for future use by a decoder (e.g., in streaming, downloading, disk access, card access, DVD, Blu-ray, etc.).

In one example, the filter coefficients are encoded and transmitted as side information in the encoded enhancement layer. Additionally, prediction coding of the filter coefficient may also be used. That is, the value of the filter coefficients for the current frame may reference filter coefficients for a previously encoded frame. As one example, the encoder may signal an instruction in the encoded bitstream for a video decoder to copy the filter coefficients from a previously decoded frame for the current frame. As another example, the encoder may signal a difference between the filter coefficients for the current frame and the filter coefficients for a previously encoded frame along with a reference index for that previously encoded frame. As other examples, the filter coefficients for the current frame could be temporally predicted, spatially predicted or temporal-spatially predicted. Direct mode, i.e., no prediction, could also be used. The prediction mode for the filter coefficients may also signaled in the encoded video bitstream.

The following syntax table shows example syntax that may be encoded in the encoded bitstream to indicate the filter coefficients. Such syntax may be encoded in the sequence parameter set, picture parameter set or slice header:

| | |
|---|---|
| C | Descriptor |

MFC_Filter_param( ) {

| | | |
|---|---|---|
| mfc_filter_idc | 2 | u(2) |
| for (i=0 ; i< mfc_filter_idc; i++) { | | |

| | | |
|---|---|---|
| number_of_coeff_1 | 2 | u(v) |
| for(j=0; j<number_of_coeff_1; j++) | | |

| | | |
|---|---|---|
| filter1_coeff[i] | 2 | u(v) |

| | | |
|---|---|---|
| number_of_coeff_2 | 2 | u(v) |
| for(j=0; j<number_of_coeff_2; j++) | | |

| | | |
|---|---|---|
| filter2_coeff[i] | 2 | u(v) |

}

}

The mfc_filter_idc syntax element indicates whether adaptive filters are used and how many sets of filters are used. If mfc_filter_idc equals to 0, no filter is used; if mfc_filter_idc equals to 1, the left and right views use the same set of filters, i.e., H₁=G₁ and H₂=G₂; if mfc_filter_idc equals to 2, different filters are used for left and right view, i.e., H₁ and H₂ for left view and G₁ and G₂ for the right view. The syntax element number_of coeff_1 specifies the number of filter taps for H₁ or G₁. The syntax element filter1_coeff is the filter coefficients for H₁ or G₁. The syntax element number_of_coeff_2 specifies the number of filter taps for H₂ or G₂. The syntax element filter2_coeff is the filter coefficients for H₂ or G₂.

Alternatively, several sets of filter coefficients according to locally changed content may be generated and signaled in slice header for each frame. For example, different sets of filter coefficients may be used for one or more content areas within a single frame. A flag may be signaled to indicate situations where the two filter sets are identical (i.e., H₁=G₁ and H₂=G₂).

The aforementioned techniques for generating filter coefficients may be done on a frame-by-frame basis. Alternatively, differently sets of filter coefficients may be estimated at a lower level (e.g., a block level or a slice level).

FIG. 6 is a block diagram illustrating an example of a video decoder 30, which decodes an encoded video sequence. The video decoder 30 will be described in the context of the H.264 video coding standard for purposes of illustration, but without limitation of this disclosure as to other coding standards or methods that may utilize techniques for coding and processing stereoscopic video data. In examples of this disclosure, the video decoder 30 may further be configured to utilize techniques of the H.264 SVC and MVC extension to perform a full resolution frame-compatible stereoscopic video coding process.

In general, the decoding process of the video decoder 30 will be the inverse of the process used by the video encoder 20 of FIG. 5 used to encode video data. As such, the encoded video data that is input to the video decoder 30 is an encoded base layer and an encoded enhancement layer as described above with reference to FIG. 5. The encoded base layer and the encoded enhancement layer may be decoded serially or in parallel. For ease of discussion, a reference to a “block” or “video block” generally refers to a block of data in a base layer or enhancement layer unless such layers are referred to specifically.

In the example of FIG. 6, the video decoder 30 includes an entropy decoding unit 70, a motion compensation unit 72, an intra-prediction unit 74, an inverse quantization unit 76, an inverse transformation unit 78, a reference frame buffer 82, a summer 80, a de-interleaver unit 84, and a post-filtering unit 86.

The entropy decoding unit 70 performs an entropy decoding process on the encoded bitstream to retrieve a one-dimensional array of transform coefficients. The entropy decoding process used depends on the entropy coding used by the video encoder 20 (e.g., CABAC, CAVLC, etc.). The entropy coding process used by the encoder may be signaled in the encoded bitstream or may be a predetermined process.

In some examples, the entropy decoding unit 70 (or the inverse quantization unit 76) may scan the received values using a scan minoring the scanning mode used by the entropy encoding unit 56 (or the quantization unit 54) of the video encoder 20. Although the scanning of coefficients may be performed in the inverse quantization unit 76, scanning will be described for purposes of illustration as being performed by the entropy decoding unit 70. In addition, although shown as separate functional units for ease of illustration, the structure and functionality of the entropy decoding unit 70, the inverse quantization unit 76, and other units of the video decoder 30 may be highly integrated with one another.

The inverse quantization unit 76 inverse quantizes, i.e., de-quantizes, the quantized transform coefficients provided in the bitstream and decoded by the entropy decoding unit 70. The inverse quantization process may include a conventional process, e.g., similar to the processes proposed for HEVC or defined by the H.264 decoding standard. The inverse quantization process may include use of a quantization parameter QP calculated by the video encoder 20 for the CU to determine a degree of quantization and, likewise, a degree of inverse quantization that should be applied. The inverse quantization unit 76 may inverse quantize the transform coefficients either before or after the coefficients are converted from a one-dimensional array to a two-dimensional array.

The inverse transform unit 78 applies an inverse transform to the inverse quantized transform coefficients. In some examples, the inverse transform unit 78 may determine an inverse transform based on signaling from the video encoder 20, or by inferring the transform from one or more coding characteristics such as block size, coding mode, or the like. In some examples, the inverse transform unit 78 may determine a transform to apply to the current block based on a signaled transform at the root node of a quadtree for an LCU including the current block. Alternatively, the transform may be signaled at the root of a TU quadtree for a leaf-node CU in the LCU quadtree. In some examples, the inverse transform unit 78 may apply a cascaded inverse transform, in which inverse transform unit 78 applies two or more inverse transforms to the transform coefficients of the current block being decoded.

The intra-prediction unit 74 may generate prediction data for a current block of a current frame based on a signaled intra-prediction mode and data from previously decoded blocks of the current frame.

The motion compensation unit 72 may produce the motion compensated blocks, possibly performing interpolation based on interpolation filters. Identifiers for interpolation filters to be used for motion estimation with sub-pixel precision may be included in the syntax elements. The motion compensation unit 72 may use interpolation filters as used by the video encoder 20 during encoding of the video block to calculate interpolated values for sub-integer pixels of a reference block. The motion compensation unit 72 may determine the interpolation filters used by the video encoder 20 according to received syntax information and use the interpolation filters to produce predictive blocks.

Additionally, the motion compensation unit 72 and the intra-prediction unit 74, in an HEVC example, may use some of the syntax information (e.g., provided by a quadtree) to determine sizes of LCUs used to encode frame(s) of the encoded video sequence. The motion compensation unit 72 and the intra-prediction unit 74 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence.

The summer 80 combines the residual blocks with the corresponding prediction blocks generated by the motion compensation unit 72 or the intra-prediction unit 74 to form decoded blocks. If desired, a deblocking filter may also be applied to filter the decoded blocks in order to remove blockiness artifacts. The decoded video blocks are then stored in the reference frame buffer 82.

At this point, the decoded video blocks are in the form of a decoded base layer and a decoded enhancement layer, for example the decoded base layer 41 and the decoded enhancement layer 43 of FIG. 3. The de-interleaver unit 84 de-interleaves the decoded base layer and decoded enhancement layer to reconstruct a decoded left view and a decoded right view. The de-interleaver unit 84 may perform a de-interleaving process as described above with reference to FIG. 3. Again, this example shows side-by-side frame packing, but other packing arrangement may be used.

The post-filtering unit 86 then retrieves the filter coefficients signaled in the encoded bitstream by an encoder and applies the filter coefficients to the decoded left view and the decoded right view. The filtered left view and right view are then ready for display, such as on the display device 32 of FIG. 4.

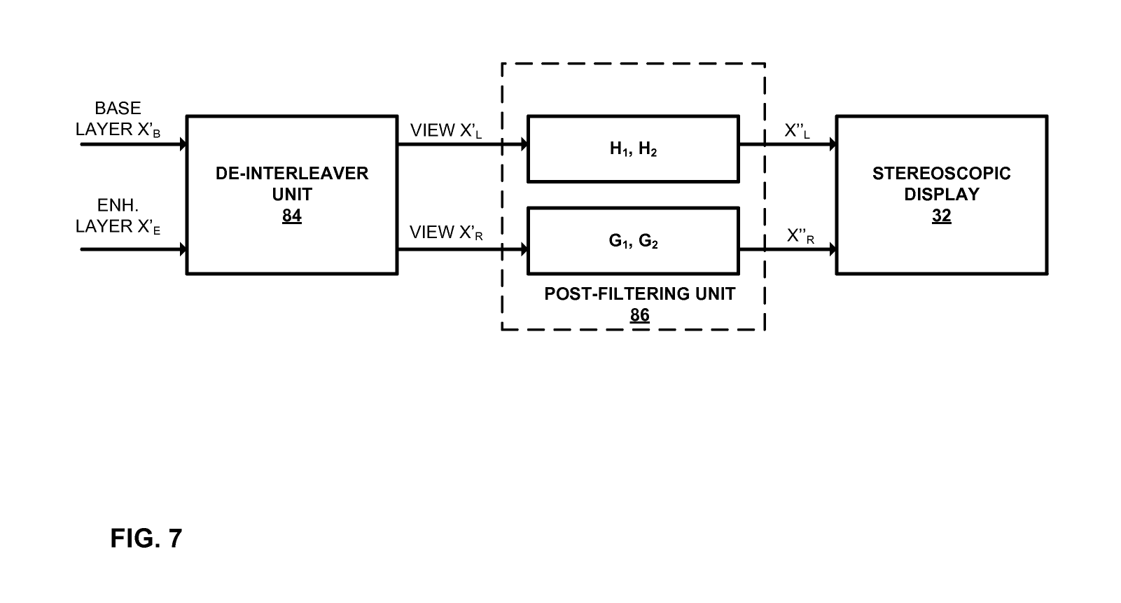

FIG. 7 is a block diagram illustrating an example post-filtering system in more detail. The original left and right views can be denoted as X_{L} and X_{R}. The base layer and enhancement layers X_{B} and X_{E} are generated from X_{L} and X_{R}. X′_{B} represents the decoded base layer while X′_{E} represents the decoded enhancement layer. After de-interleaving by the de-interleaver unit 84, the decoded left view X′_{L} and the decoded right view X′_{R} are input to the post-filtering unit 86. The post filtering unit 86 retrieves the sets of filter coefficients H₁, H₂ and G₁, G₂ from the encoded bitstream. The post-filtering unit then applies the filter coefficients H₁, H₂ and G₁, G₂ to the decoded left and right views to produces a filtered left view X″_{L} and a filtered right view X″_{R}.

The following describes example techniques for apply the filter coefficients. In this example, it is assumed that the filter shape is rectangular, however other filter shapes may be used (e.g., diamond shaped). The following post-filtering procedures are performed:

$${X}_{L}^{″} = \{ \begin{matrix}{H}_{1} * {X}_{L}^{′} & for even column pixels \\ {H}_{2} * {X}_{L}^{′} & for odd column pixels\end{matrix} \\ {X}_{R}^{″} = \{ \begin{matrix}{G}_{1} * {X}_{R}^{′} & for even column pixels \\ {G}_{2} * {X}_{R}^{′} & for odd column pixels\end{matrix} \qquad ( 7 )$$

More specifically, the convolutions for the left and right views are:

$$\begin{matrix}{x}_{L , ( 2 , j )}^{″} = {\sum }_{k = - n}^{n} {\sum }_{l = - m}^{m} {h}_{1 , ( k , l )} \cdot {x}_{L , ( 2 i + k , j + 1 )}^{′} & ( 8 ) \\ {x}_{L , ( 2 i + 1 , j )}^{″} = {\sum }_{k = - n}^{n} {\sum }_{l = - m}^{m} {h}_{2 , ( k , l )} \cdot {x}_{L , ( 2 i + 1 + k , j + l )}^{′} & ( 9 ) \\ {x}_{R , ( 2 i , j )}^{″} = {\sum }_{k = - n}^{n} {\sum }_{l = - m}^{m} {g}_{1 , ( k , l )} \cdot {x}_{R , ( 2 i + k , j + l )}^{′} & ( 10 ) \\ {x}_{R , ( 2 i + 1 , j )}^{″} = {\sum }_{k = - n}^{n} {\sum }_{l = - m}^{m} {g}_{2 , ( k , l )} \cdot {x}_{R , ( 2 i + 1 + k , j + l )}^{′} & ( 11 )\end{matrix}$$

Equation (8) shows the filtering process for even rows of the left view, equation (9) shows the filtering process for odd rows of the left view, equation (10) shows the filtering process for even rows of the right view, and equation (11) shows the filtering process for odd rows of the right view. x′_{L,(i,j)} is the pixel of the left view X′_{L} at the ith column and jth row, x′_{R,(i,j)} is the pixel of the right view X′_{R} at the ith column and jth row, and H₁={h_{1,(k,l)}}, H₂={h_{2,(k,l)}}, G₁={g_{1,(k,l)}} and G₁={g_{1,(k,l)}} are the filter coefficients. Note that in the above post-filtering operation, different sets of filters H and G are applied to left view and right view separately. However, the filter set Hand filter set G might be identical, e.g., H₁=G₁, H₂=G₂. In that case, the left and right views are post-filtered by the same set of filters.

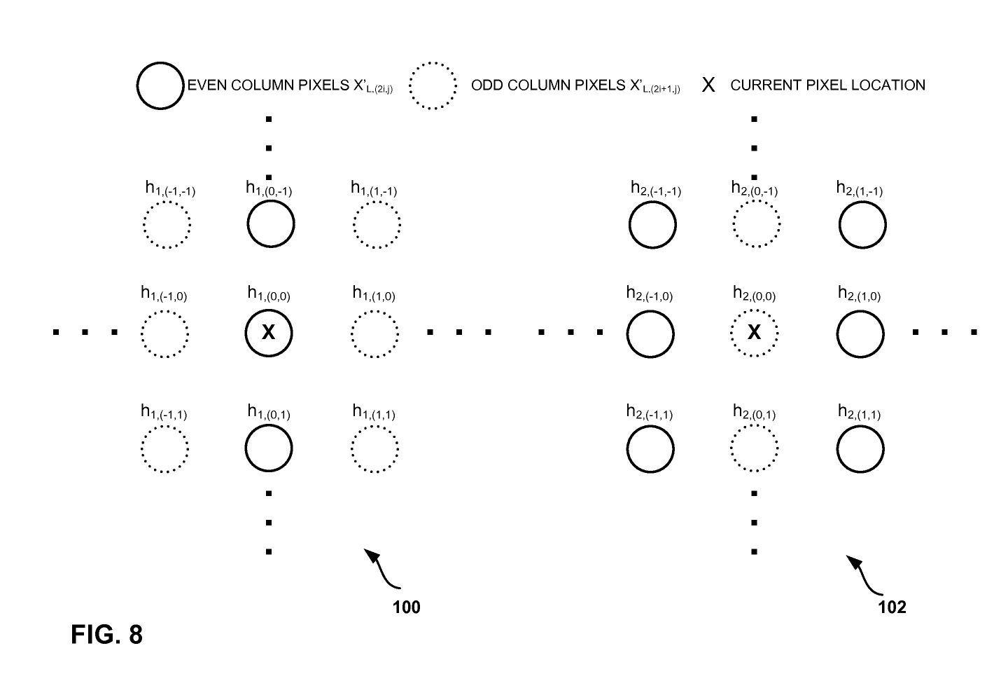

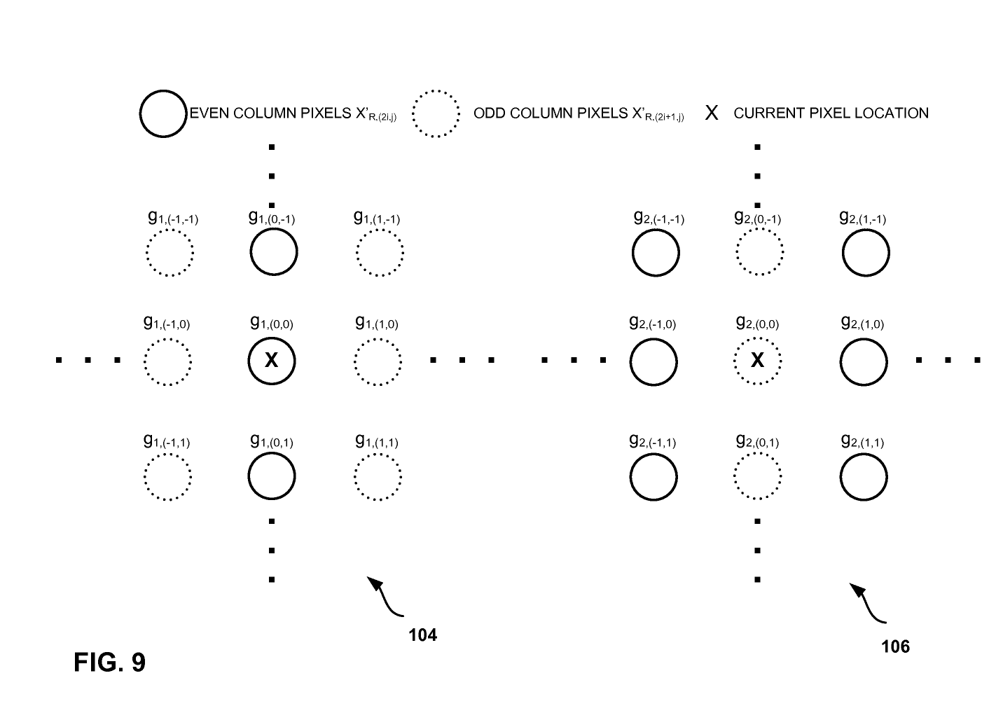

In general, the convolutions of equations (8)-(11) involve multiplying the filter coefficients to each pixel in the decoded left/right view picture within a window around a current pixel in a portion of the left/right view picture (e.g., even or odd columns) and summing the multiplied pixels to obtain a filtered value for the current pixel. An example of the filtering operation for the decoded left view and decoded right view X′_{R} is shown in FIG. 8 and FIG. 9, respectively.

FIG. 8 is a conceptual diagram illustrating an example filter mask for a left view picture. Filter mask 100 is a 3 pixel by 3 pixel mask around a current pixel (0,0) in an even column. The 3×3 mask is just an example; other mask sizes could be used. Even column pixels are shown as solid circles, while odd column pixels are shown as dotted circles. The filtered value for the current pixel (0,0) is calculated by multiplying the respective filter coefficients h₁ to each of the pixel values within the 3×3 mask and summing those values to produce the filtered value for the current pixel. Similarly, pixel mask 102 represents the process for applying the filter coefficients h₂ to pixels in the mask surround a current pixel in an odd column. FIG. 9 is a conceptual diagram illustrating an example filter mask for a right view picture. Similar to that shown in FIG. 8, pixel mask 104 shows the process for applying filter coefficients g₁ to current pixels in even columns of the right view picture, while pixel mask 106 shows the process for applying filter coefficients g₂ to the current pixels in odd columns of the right view picture.

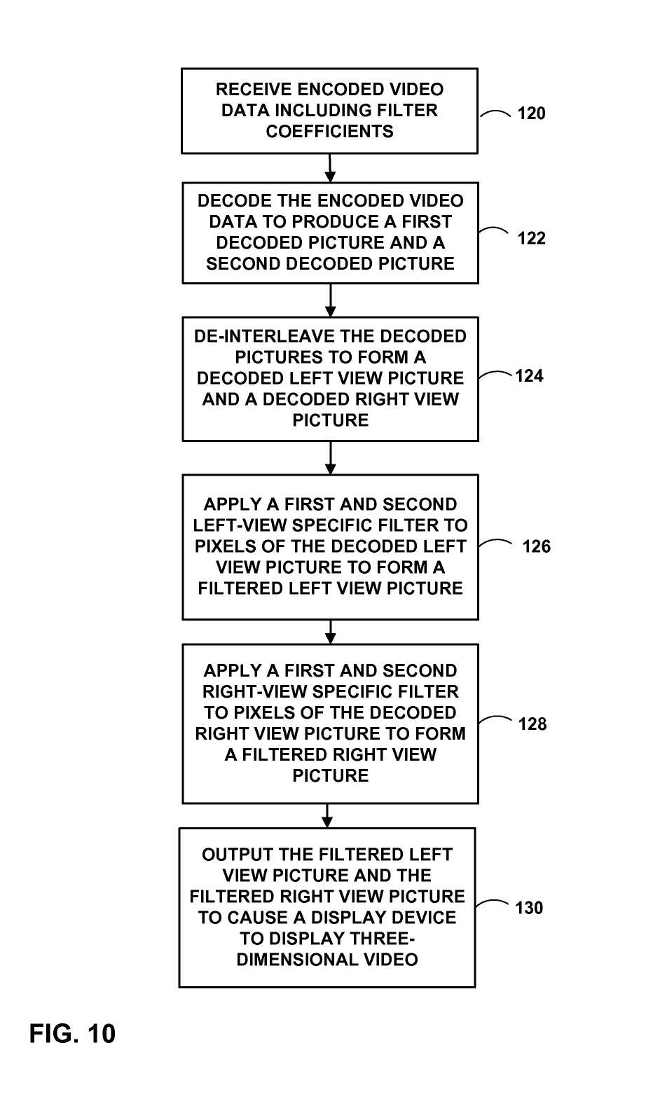

FIG. 10 is a flowchart illustrating an example method of decoding and filtering stereoscopic video. The following method may be performed by the video decoder 30 of FIG. 6. Initially, the video decoder receives encoded video data including filter coefficients (120). In one example, the encoded video data was encoded according to a full resolution frame-compatible stereoscopic video coding process. The full resolution frame-compatible stereoscopic video coding process may comply with the multi-view coding (MVC) extension of the H.264/advanced video coding (AVC) standard. In another example, the full resolution frame-compatible stereoscopic video coding process may comply with the scalable video coding (SVC) extension of the H.264/advanced video coding (AVC) standard, and the encoded video data consists of an encoded base layer with half resolution versions of right and left view pictures. The encoded video further consists of an encoded enhancement layer with complementary half resolution versions of the right and left view pictures.

The received filter coefficients may include a first left-view specific filter, a first right-view specific filter, a second left-view specific filter, and a second right-view specific filter. In one example, the filter coefficients are received in side information in the enhancement layer. The received filter coefficients may apply to one frame of the left and right views or may apply to blocks or slices of the left and right views.

After receiving the encoded video data, the decoder decodes the encoded video data to produce a first decoded picture and a second decoded picture (122). The first decoded picture may comprise a base layer and the second decoded picture may comprise an enhancement layer, wherein the base layer includes a first portion (e.g., odd columns) of the left view picture and a first portion (e.g., odd columns) of the right view picture, and wherein the enhancement layer includes the second portion of the left view picture (e.g., even columns) and the second portion of the right view picture (e.g., even columns).

After decoding the encoded video data for the base layer and the enhancement layer, the video decoder de-interleaves the decoded picture to form a decoded left view picture and a decoded right view picture, wherein the decoded picture includes the first portion of a left view picture, the first portion of a right view picture, the second portion of a left view picture, and the second portion of a right view picture (124).

The video decoder may then apply the first left-view specific filter to pixels of the decoded left view picture and apply the second left-view specific filter to pixels of the decoded left view picture to form a filtered left view picture (126). Similarly, the video decoder may apply the first right-view specific filter to pixels of the decoded right view picture and apply the second right-view specific filter to pixels of the decoded right view picture to form a filtered right view picture (128).

Applying the first left-view specific filter comprises multiplying the filter coefficients for the first left-view specific filter to each pixel in the decoded left view picture within a window around a current pixel in the first portion of the left view picture and summing the multiplied pixels to obtain a filtered value for the current pixel in the first portion of the left view picture. Applying the second left-view specific filter comprises multiplying the filter coefficients for the second left-view specific filter to each pixel in the decoded left view picture within a window around a current pixel in the second portion of the left view picture and summing the multiplied pixels to obtain a filtered value for the current pixel in the second portion of the left view picture.

Applying the first right-view specific filter comprises multiplying the filter coefficients for the first right-view specific filter to each pixel in the decoded right view picture within a window around a current pixel in the first portion of the right view picture and summing the multiplied pixels to obtain a filtered value for the current pixel in the first portion of the right view picture. Applying the second right-view specific filter comprises multiplying the filter coefficients for the second right-view specific filter to each pixel in the decoded right view picture within a window around a current pixel in the second portion of the right view picture and summing the multiplied pixels to obtain a filtered value for the current pixel in the second portion of the right view picture. The window for each of the filters may have a rectangular shape. In other examples, the window for the filters has a diamond shape.

The video decoder may then output the filtered left view picture and the filtered right view picture to cause a display device to display three-dimensional video comprising the filtered left view picture and the filtered right view picture (130).

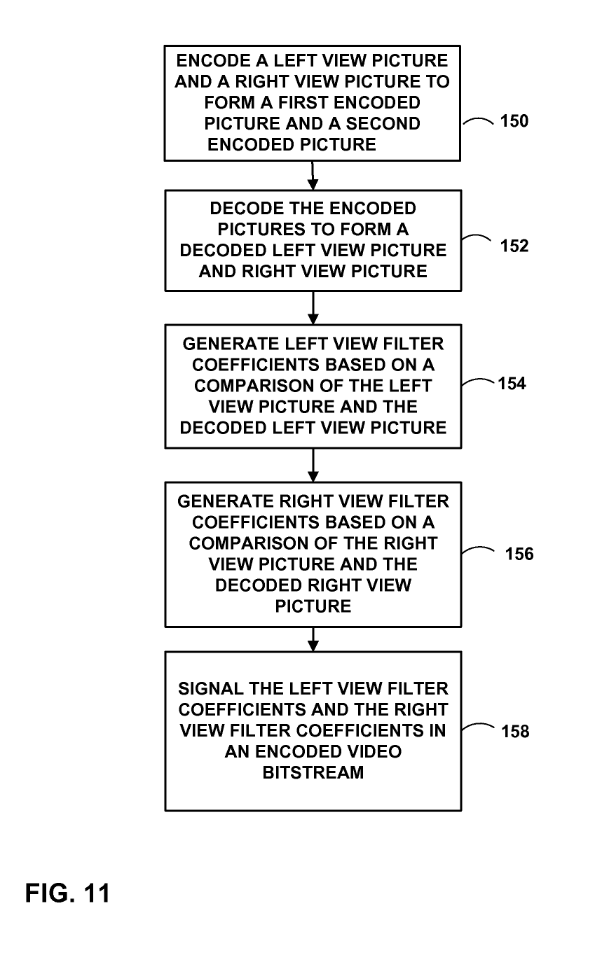

FIG. 11 is a flowchart illustrating an example method of encoding stereoscopic video and generating filter coefficients. The following method may be performed by the video encoder 20 of FIG. 5.

The video encoder may first encode a left view picture and a right view picture to form a first encoded picture and a second encoded picture (150). The left view picture may include a first left view portion (e.g., odd columns) and a second left view portion (e.g., even columns), and the right view picture may include a first right view portion (e.g., odd columns) and a second right view portion (e.g., even columns). The encoding process may include interleaving the first left view portion and the first right view portion in a base layer and interleaving the second left view portion and the second right view portion in an enhancement layer and encoding the base layer and the enhancement layer to form the first encoded picture and the second encoded picture.

Such an encoding process may be a full resolution frame-compatible stereoscopic video coding process, which may be compatible with the multi-view coding (MVC) extension and/or scalable video coding (SVC) extension of the H.264/advanced video coding (AVC) standard.

Next, the video encoder may decode the encoded pictures to form a decoded left view picture and a decoded right view picture (152). The video encoder may then generate left view filter coefficients based on a comparison of the left view picture and the decoded left view picture (154) and may generate right view filter coefficients based on a comparison of the right view picture and the decoded right view picture (156).

Generating left view filter coefficients may include generating first left view filter coefficients based on a comparison of the first left view portion a first portion of the decoded left view picture and generating second left view filter coefficients based on a comparison of the second left view portion and a second portion of the decoded left view picture. Generating right view filter coefficients may include generating first right view filter coefficients based on a comparison of the first right view portion a first portion of the decoded right view picture and generating second right view filter coefficients based on a comparison of the second right view portion and a second portion of the decoded right view picture.

In one example of the disclosure, the left view filter coefficients are generated by minimizing the mean-squared error between a filtered version of the decoded left view picture and the left view picture. Likewise, the right view filter coefficients are generated by minimizing a mean-squared error of a between a filtered version of the decoded right view picture and the right view picture.

The video encoder may then, signal the left view filter coefficients and the right view filter coefficients in an encoded video bitstream. For example, the filter coefficients may be signaled in side information of the enhancement layer.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for processing decoded video data comprising:
de-interleaving a first decoded picture and a second decoded picture to form a decoded left view picture and a decoded right view picture, wherein the first decoded picture includes a first portion of a left view picture and a first portion of a right view picture, and wherein the second decoded picture includes a second portion of a left view picture and a second portion of a right view picture;
applying a first left-view specific filter to pixels of the decoded left view picture and applying a second left-view specific filter to the pixels of the decoded left view picture to form a filtered left view picture;
applying a first right-view specific filter to pixels of the decoded right view picture and applying a second right-view specific filter to the pixels of the decoded right view picture to form a filtered right view picture; and
outputting the filtered left view picture and the filtered right view picture to cause a display device to display three-dimensional video comprising the filtered left view picture and the filtered right view picture.

2. The method of claim 1, further comprising:
displaying the filtered left view picture and the filtered right view picture.

3. The method of claim 1, further comprising:
receiving encoded video data; and
decoding the encoded video data to produce the first decoded picture and the second decoded picture.

4. The method of claim 3, wherein the encoded video data was encoded according to a full resolution frame-compatible stereoscopic video coding process.

5. The method of claim 4, wherein the full resolution frame-compatible stereoscopic video coding process complies with the multi-view coding (MVC) extension of the H.264/advanced video coding (AVC) standard.

6. The method of claim 1, wherein the first decoded picture comprises a base layer and the second decoded pictures comprises an enhancement layer, wherein the base layer includes the first portion of the left view picture and the first portion of the right view picture, and wherein the enhancement layer includes the second portion of the left view picture and the second portion of the right view picture.

7. The method of claim 6, wherein the first portion of the left view picture corresponds to odd-numbered columns of the left view picture, the second portion of the left view picture corresponds to even-numbered columns of the left view picture, the first portion of the right view picture corresponds to odd-numbered columns of the right view picture, and the second portion of the right view picture corresponds to even-numbered columns of the right view picture.

8. The method of claim 6, further comprising:
receiving filter coefficients for the first left-view specific filter, the first right-view specific filter, the second left-view specific filter, and the second right-view specific filter.

9. The method of claim 8, wherein receiving the filter coefficients comprises receiving the filter coefficients for the first left-view specific filter, the first right-view specific filter, the second left-view specific filter, and the second right-view specific filter in side information in the enhancement layer.

10. The method of claim 8, wherein the received filter coefficients apply to one frame of video data.

11. The method of claim 8,
wherein applying the first left-view specific filter comprises multiplying the filter coefficients for the first left-view specific filter to each pixel in the decoded left view picture within a window around a current pixel in the first portion of the left view picture and summing the multiplied pixels to obtain a filtered value for the current pixel in the first portion of the left view picture,
wherein applying the second left-view specific filter comprises multiplying the filter coefficients for the second left-view specific filter to each pixel in the decoded left view picture within a window around a current pixel in the second portion of the left view picture and summing the multiplied pixels to obtain a filtered value for the current pixel in the second portion of the left view picture,
wherein applying the first right-view specific filter comprises multiplying the filter coefficients for the first right-view specific filter to each pixel in the decoded right view picture within a window around a current pixel in the first portion of the right view picture and summing the multiplied pixels to obtain a filtered value for the current pixel in the first portion of the right view picture, and
wherein applying the second right-view specific filter comprises multiplying the filter coefficients for the second right-view specific filter to each pixel in the decoded right view picture within a window around a current pixel in the second portion of the right view picture and summing the multiplied pixels to obtain a filtered value for the current pixel in the second portion of the right view picture.

12. The method of claim 11, wherein the window has a rectangular shape.

13. A method for encoding video data comprising:
encoding a left view picture and a right view picture to form a first encoded picture and a second encoded picture;
decoding the first encoded picture and the second encoded picture to form a decoded left view picture and a decoded right view picture;
generating left view filter coefficients based on a comparison of the left view picture and the decoded left view picture; and
generating right view filter coefficients based on a comparison of the right view picture and the decoded right view picture.

14. The method of claim 13, further comprising:
signaling the left view filter coefficients and the right view filter coefficients in an encoded video bitstream.

15. The method of claim 13, wherein the left view picture includes a first left view portion and a second left view portion, and wherein the right view picture includes a first right view portion and a second right view portion.

16. The method of claim 15, wherein encoding the left view picture and the right view picture comprises:
interleaving the first left view portion and the first right view portion in a base layer;
interleaving the second left view portion and the second right view portion in an enhancement layer; and
encoding the base layer and the enhancement layer to form the encoded picture.

17. The method of claim 16,
wherein generating left view filter coefficients comprises generating first left view filter coefficients based on a comparison of the first left view portion a first portion of the decoded left view picture and generating second left view filter coefficients based on a comparison of the second left view portion and a second portion of the decoded left view picture, and
wherein generating right view filter coefficients comprises generating first right view filter coefficients based on a comparison of the first right view portion a first portion of the decoded right view picture and generating second right view filter coefficients based on a comparison of the second right view portion and a second portion of the decoded right view picture.

18. The method of claim 13,
wherein the left view filter coefficients are generated by minimizing the mean-squared error between a filtered version of the decoded left view picture and the left view picture, and
wherein the right view filter coefficients are generated by minimizing a mean-squared error of a between a filtered version of the decoded right view picture and the right view picture.

19. The method of claim 13, wherein encoding the left view picture and the right view picture comprises encoding the left view picture and the right view picture using a full resolution frame-compatible stereoscopic video coding process.

20. The method of claim 19, wherein the full resolution frame-compatible stereoscopic video coding process complies with the multi-view coding (MVC) extension of the H.264/advanced video coding (AVC) standard.

21. An apparatus for processing decoded video data comprising:
a video decoding unit configured to:
de-interleave a first decoded picture and a second decoded picture to form a decoded left view picture and a decoded right view picture, wherein the first decoded picture includes a first portion of a left view picture and a first portion of a right view picture, and wherein the second decoded picture includes a second portion of a left view picture and a second portion of a right view picture;
apply a first left-view specific filter to pixels of the decoded left view picture and apply a second left-view specific filter to the pixels of the decoded left view picture to form a filtered left view picture;
apply a first right-view specific filter to pixels of the decoded right view picture and apply a second right-view specific filter to the pixels of the decoded right view picture to form a filtered right view picture; and
output the filtered left view picture and the filtered right view picture to cause a display device to display three-dimensional video comprising the filtered left view picture and the filtered right view picture.

22. The apparatus of claim 21, further comprising:
a display unit configured to display the filtered left view picture and the filtered right view picture.

23. The apparatus of claim 21, wherein the video decoding unit is further configured to:
receive encoded video data; and
decode the encoded video data to produce the first decoded picture and the second decoded picture.

24. The apparatus of claim 23, wherein the encoded video data was encoded according to a full resolution frame-compatible stereoscopic video coding process.

25. The apparatus of claim 24, wherein the full resolution frame-compatible stereoscopic video coding process complies with the multi-view coding (MVC) extension of the H.264/advanced video coding (AVC) standard.

26. The apparatus of claim 21, wherein the first decoded picture comprises a base layer and the second decoded picture comprises an enhancement layer, wherein the base layer includes the first portion of the left view picture and the first portion of the right view picture, and wherein the enhancement layer includes the second portion of the left view picture and the second portion of the right view picture.

27. The apparatus of claim 26, wherein the first portion of the left view picture corresponds to odd-numbered columns of the left view picture, the second portion of the left view picture corresponds to even-numbered columns of the left view picture, the first portion of the right view picture corresponds to odd-numbered columns of the right view picture, and the second portion of the right view picture corresponds to even-numbered columns of the right view picture.

28. The apparatus of claim 26, wherein the video decoding unit is further configured to:
receive filter coefficients for the first left-view specific filter, the first right-view specific filter, the second left-view specific filter, and the second right-view specific filter.

29. The apparatus of claim 28, wherein the video decoding unit is further configured to:
receive the filter coefficients for the first left-view specific filter, the first right-view specific filter, the second left-view specific filter, and the second right-view specific filter in side information in the enhancement layer.

30. The apparatus of claim 28, wherein the received filter coefficients apply to one frame of video data.

31. The apparatus of claim 28, wherein the video decoding unit is further configured to:
multiply the filter coefficients for the first left-view specific filter to each pixel in the decoded left view picture within a window around a current pixel in the first portion of the left view picture and sum the multiplied pixels to obtain a filtered value for the current pixel in the first portion of the left view picture,
multiply the filter coefficients for the second left-view specific filter to each pixel in the decoded left view picture within a window around a current pixel in the second portion of the left view picture and sum the multiplied pixels to obtain a filtered value for the current pixel in the second portion of the left view picture,
multiply the filter coefficients for the first right-view specific filter to each pixel in the decoded right view picture within a window around a current pixel in the first portion of the right view picture and sum the multiplied pixels to obtain a filtered value for the current pixel in the first portion of the right view picture, and
multiply the filter coefficients for the second right-view specific filter to each pixel in the decoded right view picture within a window around a current pixel in the second portion of the right view picture and sum the multiplied pixels to obtain a filtered value for the current pixel in the second portion of the right view picture.

32. The apparatus of claim 31, wherein the window has a rectangular shape.

33. An apparatus for encoding video data comprising:
a video encoding unit configured to:
encode a left view picture and a right view picture to form a first encoded picture and a second encoded picture;
decode the first encoded picture and the second encoded picture to form a decoded left view picture and a decoded right view picture;
generate left view filter coefficients based on a comparison of the left view picture and the decoded left view picture; and
generate right view filter coefficients based on a comparison of the right view picture and the decoded right view picture.

34. The apparatus of claim 33, wherein the video encoding unit is further configured to:
signal the left view filter coefficients and the right view filter coefficients in an encoded video bitstream.

35. The apparatus of claim 33, wherein the left view picture includes a first left view portion and a second left view portion, and wherein the right view picture includes a first right view portion and a second right view portion.

36. The apparatus of claim 35, wherein the video encoding unit is further configured to:
interleave the first left view portion and the first right view portion in a base layer;
interleave the second left view portion and the second right view portion in an enhancement layer; and
encode the base layer and the enhancement layer to form the first encoded picture and the second encoded picture.

37. The apparatus of claim 36, wherein the video encoding unit is further configured to:
generate first left view filter coefficients based on a comparison of the first left view portion a first portion of the decoded left view picture;
generate second left view filter coefficients based on a comparison of the second left view portion and a second portion of the decoded left view picture;
generate first right view filter coefficients based on a comparison of the first right view portion a first portion of the decoded right view picture; and
generate second right view filter coefficients based on a comparison of the second right view portion and a second portion of the decoded right view picture.

38. The apparatus of claim 33,
wherein the left view filter coefficients are generated by minimizing the mean-squared error between a filtered version of the decoded left view picture and the left view picture, and
wherein the right view filter coefficients are generated by minimizing a mean-squared error of a between a filtered version of the decoded right view picture and the right view picture.

39. The apparatus of claim 33, wherein the video encoding unit is further configured to:
encode the left view picture and the right view picture using a full resolution frame-compatible stereoscopic video coding process.

40. The apparatus of claim 39, wherein the full resolution frame-compatible stereoscopic video coding process complies with the multi-view coding (MVC) extension of the H.264/advanced video coding (AVC) standard.

41. An apparatus for processing decoded video data comprising:
means for de-interleaving a first decoded picture and a second decoded picture to form a decoded left view picture and a decoded right view picture, wherein the first decoded picture includes a first portion of a left view picture and a first portion of a right view picture, and wherein the second decoded picture includes a second portion of a left view picture and a second portion of a right view picture;
means for applying a first left-view specific filter to the pixels of the decoded left view picture and applying a second left-view specific filter to the pixels of the decoded left view picture to form a filtered left view picture;
means for applying a first right-view specific filter to the pixels of the decoded right view picture and applying a second right-view specific filter to the pixels of the decoded right view picture to form a filtered right view picture; and
means for outputting the filtered left view picture and the filtered right view picture to cause a display device to display three-dimensional video comprising the filtered left view picture and the filtered right view picture.

42. The apparatus of claim 41, wherein the first decoded picture comprises a base layer and the second decoded picture comprises an enhancement layer, wherein the base layer includes the first portion of the left view picture and the first portion of the right view picture, and wherein the enhancement layer includes the second portion of the left view picture and the second portion of the right view picture.

43. The apparatus of claim 42, wherein the first portion of the left view picture corresponds to odd-numbered columns of the left view picture, the second portion of the left view picture corresponds to even-numbered columns of the left view picture, the first portion of the right view picture corresponds to odd-numbered columns of the right view picture, and the second portion of the right view picture corresponds to even-numbered columns of the right view picture.

44. The apparatus of claim 42, further comprising:
means for receiving filter coefficients for the first left-view specific filter, the first right-view specific filter, the second left-view specific filter, and the second right-view specific filter.

45. The apparatus of claim 44,
wherein the means for applying the first left-view specific filter comprises means for multiplying the filter coefficients for the first left-view specific filter to each pixel in the decoded left view picture within a window around a current pixel in the first portion of the left view picture and summing the multiplied pixels to obtain a filtered value for the current pixel in the first portion of the left view picture,
wherein the means for applying the second left-view specific filter comprises means for multiplying the filter coefficients for the second left-view specific filter to each pixel in the decoded left view picture within a window around a current pixel in the second portion of the left view picture and summing the multiplied pixels to obtain a filtered value for the current pixel in the second portion of the left view picture,
wherein the means for applying the first right-view specific filter comprises means for multiplying the filter coefficients for the first right-view specific filter to each pixel in the decoded right view picture within a window around a current pixel in the first portion of the right view picture and summing the multiplied pixels to obtain a filtered value for the current pixel in the first portion of the right view picture, and
wherein the means for applying the second right-view specific filter comprises means for multiplying the filter coefficients for the second right-view specific filter to each pixel in the decoded right view picture within a window around a current pixel in the second portion of the right view picture and summing the multiplied pixels to obtain a filtered value for the current pixel in the second portion of the right view picture.

46. A computer program product comprising a computer-readable storage medium having stored thereon instructions that, when executed, cause a processor of a device for processing decoded video data to:
de-interleave a first decoded picture and a second decoded picture to form a decoded left view picture and a decoded right view picture, wherein the first decoded picture includes a first portion of a left view picture and a first portion of a right view picture, and wherein the second decoded picture includes a second portion of a left view picture, and a second portion of a right view picture;
apply a first left-view specific filter to the pixels of the decoded left view picture and apply a second left-view specific filter to the pixels of the decoded left view picture to form a filtered left view picture;
apply a first right-view specific filter to the pixels of the decoded right view picture and apply a second right-view specific filter to the pixels of the decoded right view picture to form a filtered right view picture; and
output the filtered left view picture and the filtered right view picture to cause a display device to display three-dimensional video comprising the filtered left view picture and the filtered right view picture.

47. The computer program product of claim 46, wherein the first decoded picture comprises a base layer and the second decoded picture comprises an enhancement layer, wherein the base layer includes the first portion of the left view picture and the first portion of the right view picture, and wherein the enhancement layer includes the second portion of the left view picture and the second portion of the right view picture.

48. The computer program product of claim 47, wherein the first portion of the left view picture corresponds to odd-numbered columns of the left view picture, the second portion of the left view picture corresponds to even-numbered columns of the left view picture, the first portion of the right view picture corresponds to odd-numbered columns of the right view picture, and the second portion of the right view picture corresponds to even-numbered columns of the right view picture.

49. The computer program product of claim 47, further causing a processor to:
receive filter coefficients for the first left-view specific filter, the first right-view specific filter, the second left-view specific filter, and the second right-view specific filter.

50. The computer program product of claim 49, further causing a processor to:
multiply the filter coefficients for the first left-view specific filter to each pixel in the decoded left view picture within a window around a current pixel in the first portion of the left view picture and sum the multiplied pixels to obtain a filtered value for the current pixel in the first portion of the left view picture,
multiply the filter coefficients for the second left-view specific filter to each pixel in the decoded left view picture within a window around a current pixel in the second portion of the left view picture and sum the multiplied pixels to obtain a filtered value for the current pixel in the second portion of the left view picture,
multiply the filter coefficients for the first right-view specific filter to each pixel in the decoded right view picture within a window around a current pixel in the first portion of the right view picture and sum the multiplied pixels to obtain a filtered value for the current pixel in the first portion of the right view picture, and
multiply the filter coefficients for the second right-view specific filter to each pixel in the decoded right view picture within a window around a current pixel in the second portion of the right view picture and sum the multiplied pixels to obtain a filtered value for the current pixel in the second portion of the right view picture.
